(19) United States
(12) Patent Application Publication
(10) Pub. No.: US 2012/0300240 A1
(43) Pub. Date: Nov. 29, 2012

(54) IMAGE PROCESSING DEVICE RECEIVING REQUEST TO STOP ACTIVE JOB

(75) Inventor: Mitsutaka MORITA, Nagoya-shi (JP)

(73) Assignee: Konica Minolta Business Technologies, Inc., Chiyoda-ku (JP)

(21) Appl. No.: 13/481,065

(22) Filed: May 25, 2012

(30) Foreign Application Priority Data
May 27, 2011 (JP) 2011-119163

(51) Int. Cl. G06K 15/02

(52) U.S. Cl. 358/1.13

(57) ABSTRACT

An image processing device includes a conveying unit for performing a sheet conveying operation. The image processing device receives a stop request from a user to stop an active job. When a first kind of job, which is a job in which the sheet conveying operation is performed by the conveying unit in the active jobs, exists in the case the stop request is received, the image processing device stops the first kind of job. When receiving the stop request, the image processing device determines a second kind of job that is different from the first kind of job in the active jobs. The image processing device displays information on the second kind of job to the user based on a determination result.

This application is based on Japanese Patent Application No. 2011-119163 filed with the Japan Patent Office on May 27, 2011, the entire content of which is hereby incorporated by reference.

### BACKGROUND OF THE INVENTION

1. Field of the Invention

The present invention relates to an image processing device and an image forming device, particularly to an image processing device and an image forming device, which receive a request to stop an active job from a user.

2. Description of the Background Art

There is an image processing device including an image forming device (such as an MFP (Multi Function Peripheral) provided with a scanner function, a facsimile function, a copying function, a function as a printer, a data communication function, and a server function, a facsimile machine, a copying machine, and a printer) and an image reading apparatus. Some of image processing devices stop an active or wailing job (such as a print job and a scan job) when a user makes a stop request. The stop request is made such that the user manipulates a stop key.

Document 1 discloses that, when the stop key is pressed, the image forming device is temporarily stopped after completion of a print output of a page to which a print output process is currently performed in active jobs. In the image forming device disclosed in Document 1, a job list screen for temporarily-stopped and waiting jobs is displayed on a display panel. The user can issue an instruction to cancel a selected item in the job list screen.

Document 2 discloses that, in the image forming device, a cancel button pressing time is counted, and the currently printing print data is cancelled when the cancel button is pressed for a predetermined time. Pieces of identification information on the print data are listed when the pressing time does not reach the predetermined time.
Document 1: Japanese Patent Laid-Open No. 2008-18622
Document 2: Japanese Patent Laid-Open No. 2006-88355

A mechanical operation typified by a sheet conveying operation (such as a document conveying operation for performing a scan and a sheet feed operation for performing printing to the sheet) and an operation (hereinafter sometimes referred to as an unstoppable operation) typified by a communication operation (such as a facsimile transmission job) are performed in the image processing device. In the unstoppable operation, the operation cannot temporarily be stopped so as to be able to be resumed. When the stop key is pressed during the mechanical operation, the active mechanical operation is stopped. As used herein, the stop means the temporarily-stopped state that can be resumed. On the other hand, the active unstoppable operation is not stopped even if the stop key is pressed.

In the image processing device, it is assumed that the user who intends to stop the mechanical operation or the unstoppable operation presses the stop key while the mechanical operation or the unstoppable operation is performed. In this case, the mechanical operation is stopped, so that the user can stop this kind of operation as intended. For example, when the scan job or the print job is currently performed, because the scan job or the print job is stopped, an excess output, namely, an increase in waste can be prevented. However, the unstoppable operation is not stopped even if the stop key is pressed, the unstoppable operation is continuously performed despite the intention of the user. For example, even if the stop key is pressed during the facsimile transmission, the transmission operation is continued.

The user can relatively easily determine whether the mechanical operation is currently performed by existence or non-existence of an operation sound or a sheet movement. On the other hand, sometimes the user cannot easily determine whether the unstoppable operation is currently performed. That is, for example, the unstoppable operation is the communication operation that is not associated with the mechanical operation, and the mechanical operation sound is not generated during the communication operation. Therefore, sometimes the user cannot easily determine whether the unstoppable operation is currently performed in a visual manner.

The following problem is generated because whether the unstoppable operation is currently performed cannot intuitively be determined. When the stop key is pressed during the unstoppable operation, sometimes the user does not notice that the unstoppable operation is not stopped. When the user presses the stop key with the intention of stopping the unstoppable operation, the unintended operation of the user is performed.

Particularly, in a multi-operation in which plural operations (jobs) including the mechanical operation and the unstoppable operation are performed, the problem becomes prominent when the user who intends to stop the multi-operation presses the stop key. In this case, the mechanical operation is stopped by pressing the stop key, while the unstoppable operation is not stopped. On the other hand, the user can easily recognize that the mechanical operation is stopped. At this point, due to the stop of the mechanical operation, the user is likely to mistakenly recognize that both the mechanical operation and the unstoppable operation are stopped.

In the image forming device disclosed in Document 1, when the stop key is pressed, the job list screen for the list of temporarily-stopped and waiting jobs is displayed on the display panel. However, all the jobs are displayed in the same list. That is, in the image forming device, whether the unstoppable operation is currently performed cannot easily be determined when the stop key is pressed.

In Documents 1 and 2, there is disclosed no effective solution to the problem with the operation that cannot be stopped.

An object of the invention is to provide an image processing device and an image forming device in which, when the stop request is made during the temporarily unstoppable job, the user can easily recognize that the temporarily unstoppable job is currently performed.

### SUMMARY OF THE INVENTION

According to an aspect of the invention, an image processing device includes: a conveying unit for performing a sheet conveying operation; a receiving unit for receiving a stop request from a user to stop a job that is currently performed by the image processing device; a stopping instruction unit for stopping a first kind of job when the first kind of job exists in the case that the receiving unit receives the stop request, the first kind of job being a job in which the sheet conveying operation is performed by the conveying unit in jobs that are currently performed by the image processing device; a determination unit for determining a second kind of job different from the first kind of job in the jobs that are currently performed by the image processing device when the receiving unit receives the stop request; and a job display unit for displaying information on the second kind of job to the user based on a determination result of the determination unit.

According to an another aspect of the invention, an image forming device includes: an image forming unit for forming an image on a sheet; and the image processing device, wherein the conveying unit performs the operation to convey the sheet used in the image forming unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of an image forming system according to an embodiment of the invention.

FIG. 2 is a perspective view of an image forming device.

FIG. 3 is a block diagram illustrating hardware configurations of the image forming device and a server of the image forming system.

FIG. 4 is a flowchart illustrating an operation of the image forming device.

FIG. 5 is a view illustrating an example of a disposal selection screen that is displayed when a stop key is pressed.

FIG. 6 is a view illustrating an example of a job information display screen for disposing of a job.

FIG. 7 is a view illustrating an example of a selection manipulation for disposing of the job.

FIG. 8 is a view illustrating another example of the job information display screen.

FIG. 9 is a view illustrating an example of the job information display screen on which information on a temporarily-stopped job is displayed.

FIG. 10 is a view illustrating an example of the job information display screen when a server cooperation job is currently performed.

FIG. 11 is a view illustrating a display example when the server cooperation job currently processed by a server is selected on the job information display screen.

FIG. 12 is a sequence diagram illustrating a procedure of a searchable PDF file generating job.

FIG. 13 is a sequence diagram illustrating a procedure of an authentication pull print job in which the server is used.

FIG. 14 is a view illustrating an example of the job information display screen that is displayed after the stop key is pressed.

FIG. 15 is a view illustrating an example of the job information display screen that is displayed after the stop key is pressed.

FIG. 16 is a view illustrating an example of a delete selection manipulation receiving operation on the job information display screen.

FIG. 17 is a view illustrating an example of the job information display screen after the job is disposed of according to the delete selection manipulation.

FIG. 18 is a flowchart illustrating processing that is performed in displaying the job information display screen.

FIG. 19 is a flowchart illustrating threshold setting processing.

FIG. 20 is a view illustrating an example of the job information display screen when the number of jobs is more than a threshold.

FIG. 21 is a view illustrating an example of the job information display screen when the number of jobs is lower than the threshold.

FIG. 22 is a flowchart illustrating an example of a G3 fax transmission job operation.

FIG. 23 is a view illustrating an example of the job information display screen.

FIG. 24 is a view illustrating an example of the job information display screen.

FIG. 25 is a flowchart illustrating an example of an operation of the authentication pull print job.

FIG. 26 is a view illustrating an example of the job information display screen.

### DESCRIPTION OF THE PREFERRED EMBODIMENTS

An image forming device (an example of the image processing device) according to an embodiment of the invention will be described below.

### [Overview]

The image forming device is a multi-function peripheral (MFP) provided with the scanner function, copying function, function as a printer, facsimile transmitting/receiving function, data communicating function, and server function. With the scanner function, the image forming device reads an image from a document which has been set, and stores the read image in a hard disk drive (HDD) or the like. With the copying function, the device further prints the image on a sheet of paper or the like. With the function as a printer, on receipt of a print instruction from an external terminal such as a personal computer (PC), the device prints an image on a sheet of paper on the basis of the instruction. With the facsimile transmitting/receiving function, the device receives facsimile data from an external facsimile machine or the like and stores the data in a HDD or the like. With the data communicating function, the device transmits data to or receives data from an external device connected thereto. With the server function, the device allows a plurality of users to share, e.g., data stored in a HDD or the like.

The image forming device is connected to a server apparatus through a network. The image forming device and the server apparatus can conduct communication with each other. The image forming device can access the server to cause the server to perform various functions.

A stop key that is pressed to stop an active job is provided in the image forming device. The job associated with sheet conveying operation, such as a printing operation and a reading operation, is temporarily stopped when a user presses the stop key. When a temporarily unstoppable job is active with the stop key being pressed, information on the temporarily unstoppable job is displayed to the user on a display panel.

For the job to transmit the data, sometimes the user hardly determines the existence or non-existence of the job operation even if the user visually checks the job. However, in the image forming device, when the temporarily unstoppable job is currently performed, the information on the temporarily unstoppable job is displayed in priority to other jobs. When the stop key is pressed, the job in which the unstoppable operation, such as the facsimile transmission, is currently performed is displayed in priority to the mechanical operation, namely, the job in which the stop of the operation is visible. Therefore, when pressing the stop key, the user can easily recognize that the temporarily unstoppable job is still performed. The user can quickly notice that the unintended operation is performed, and deal with the unintended operation.

### Embodiment

FIG. 1 is a block diagram illustrating a configuration of an image forming system according to an embodiment of the invention.

Referring to FIG. 1, an image forming system 900 includes an image forming device 1, a client PC (hereinafter sometimes referred to as a PC) 401, and a server (an example of the external server) 601.

Image forming device 1, server 601, and PC 401 are connected to a network 800. For example, network 800 is a LAN (Local Area Network). Image forming device 1, server 601, and PC 401 can conduct communication with one another. Each device may be connected to network 800 through a LAN cable or what is called a wireless LAN.

### [Configuration of Image Forming Device 1]

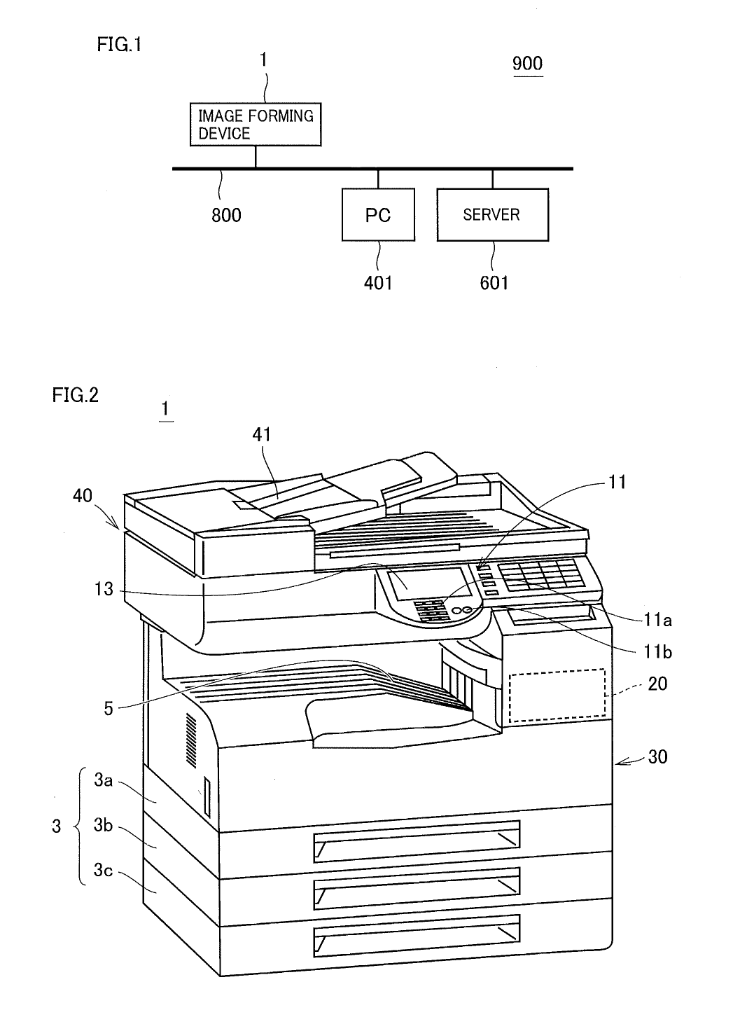

FIG. 2 is a perspective view illustrating image forming device 1.

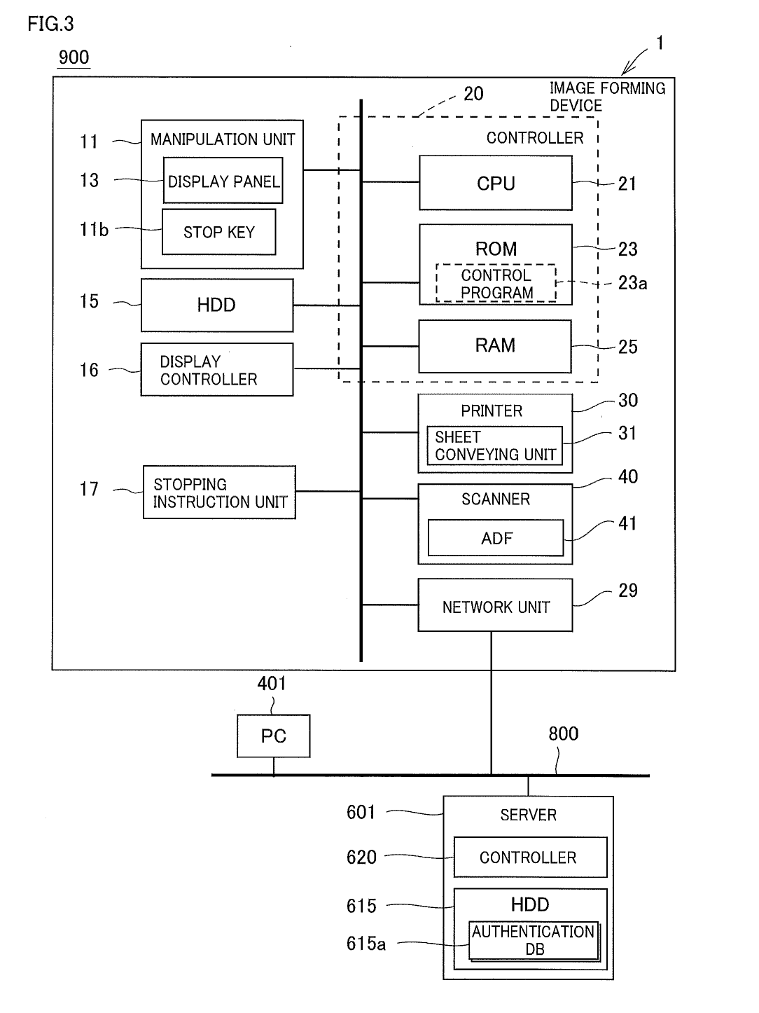

Referring to FIG. 2, image forming device 1 includes a sheet feed cassette 3, a sheet discharge tray 5, a manipulation unit (an example of the receiving unit) 11, a controller 20, a printer (an example of the image forming unit) 30, and a scanner (an example of the reader) 40. Controller 20 includes a CPU 21 (see FIG. 3) and controls an operation of image forming device 1. Controller 20 and printer 30 are disposed in a chassis of image forming device 1.

Image forming device 1 includes three sheet-feed cassettes 3 (sheet-feed cassettes 3a, 3b, and 3c). For example, sheets having different sizes (such as a B5 size, an A4 size and an A3 size) are loaded on sheet-feed cassettes 3. Sheet-feed cassettes 3 are disposed in a lower portion of image forming device 1 while being able to be inserted in and taken out from the chassis of image forming device 1. During the print, the sheets loaded in each sheet-feed cassette 3 are fed one by one and delivered to printer 30. The number of sheet-feed cassettes 3 is not limited to three, but the number of sheet-feed cassettes 3 may be larger or smaller than three.

In the chassis of image forming device 1, sheet discharge tray 5 is disposed above a region in which printer 30 is accommodated and below a region in which scanner 40 is disposed. The sheet in which the image is formed by printer 30 is discharged to sheet discharge tray 5 from an inside of the chassis.

Manipulation unit 11 is disposed on a front (front surface in FIG. 2) side in an upper portion of image forming device 1. A plurality of manipulation keys 11a that can be pressed by a user are disposed in manipulation unit 11. A Stop key 11b that is one of manipulation key 11a is disposed to manipulation unit 11. A display panel 13 that displays information to the user is disposed in manipulation unit 11.

For example, display panel 13 is an LCD (Liquid Crystal Display) provided with a touch panel. Display panel 13 displays a guide screen to the user and a manipulation key, and receives a touch manipulation from the user. Display panel 13 performs the display under the control of CPU 21. CPU 21 can show the information to a user by displaying a screen (image) indicating the information to display panel 13.

Manipulation unit 11 receives a manipulation input from the user. When the user manipulates manipulation key 11a or display panel 13, manipulation unit 11 transmits a manipulation signal or a predetermined command corresponding to the manipulation to CPU 21. That is, the user can cause image forming device 1 to perform various operations by manipulating manipulation unit 11.

Stop key 11b is provided to receive a stop request to stop the job currently performed by image forming device 1 from the user. That is, the user manipulates stop key 11b to stop the job currently performed by image forming device 1. Manipulation unit 11 receives the stop request from the user by manipulating stop key 11b. The received stop request is transmitted to CPU 21. CPU 21 performs control in response to the stop request.

Printer 30 forms the image in the sheet by an electrophotographic method in which a toner image formed by the toner image forming unit is transferred to the sheet. Printer 30 generally includes a toner image forming unit (not illustrated), a sheet conveying unit (an example of the conveying unit; shown in FIG. 3) 31, and a fixing device (not illustrated).

The sheet conveying unit 31 is constructed by a sheet feed roller, a conveying roller, and a motor that drives the sheet feed roller and the conveying roller. In the sheet conveying unit 31, the sheet is fed from sheet-feed cassette 3 and conveyed in the chassis of image forming device 1. The sheet conveying unit 31 discharges the sheet in which the image is formed to sheet discharge tray 5 from the chassis of image forming device 1.

The toner image forming unit includes a photosensitive body, a development device, an exposure device, and a transfer roller. The toner image forming unit forms the toner image, and transfers the toner image that is formed in the sheet to the sheet conveyed by the sheet conveying unit 31.

The fixing device includes a heating roller and a pressurizing roller. The fixing device conveys the sheet in which the image is formed while the sheet is nipped between the heating roller and the pressurizing roller, and heats and pressurizes the sheet. Therefore, the fixing device melts toner adhering to the sheet, and fixes the toner to the sheet to form the image in the sheet.

Scanner 40 is disposed in the upper portion of the chassis of image forming device 1. Scanner 40 includes an ADF (Auto Document Feeder; an example of the conveying unit) 41.

Scanner 40 performs the scanner function. In scanner 40, a manuscript disposed on a transparent manuscript stage is scanned with a contact image sensor and read as image data. In scanner 40, the pieces of image data of the plurality of manuscripts are read by contact image sensor while the manuscripts set in a manuscript tray are sequentially taken in by the ADF 41.

FIG. 3 is a block diagram illustrating hardware configurations of the image forming device 1 and a server 601 of the image forming system 900.

Referring to FIG. 3, image forming device 1 includes an HDD 15 and a network unit 29 in addition to the above units. Image forming device 1 includes a display controller (an example of the determination unit and an example of the job display unit) 16 and a stopping instruction unit (an example of the stopping instruction unit) 17. Display controller 16 and stopping instruction unit 17 perform an operation associated with stop key 11b. Each unit of image forming device 1 is connected to a system bus. Controller 20 can conduct communication with each unit of image forming device 1.

Data of a print job transmitted from an outside through network unit 29 and the image data read by scanner 40 are stored in HDD 15. Setting information on image forming device 1 and a control program for performing various operations of image forming device 1 are stored in HDD 15. A plurality of print jobs transmitted from one PC 401 or a plurality of PCs can be stored in HDD 15.

For example, network unit 29 is constructed by a combination of a hardware unit such as an NIC (Network Interface Card) and a software unit that conducts communication by a predetermined communication protocol. Network unit 29 connects image forming device 1 to network 800. Therefore, image forming device 1 can conduct communication with external devices, such as PC 401 and server 601, which are connected to network 800. Image forming device 1 can receive the print job from PC 401 and server 601. Image forming device 1 can transmit the image data read by scanner 40 to PC 401 by file-transfer protocol, or transmit the image data by an e-mail through a mail server (not illustrated). Network unit 29 may be configured to be able to be connected to network 800 through wireless communication.

Controller 20 includes the CPU 21, a ROM 23, and a RAM 25. Controller 20 is connected to the system bus in conjunction with manipulation unit 11, printer 30, and scanner 40. Therefore, controller 20 and each unit of image forming device 1 are connected to each other so as to be able to transmit and receive the signal.

For example, ROM 23 is a flash ROM (flash memory). The data used to perform the operation of image forming device 1 is stored in ROM 23. Various control programs 23a or image data 23d are stored in ROM 23. Function setting data of image forming device 1 may be stored in ROM 23. CPU 21 reads the data from ROM 23 and writes the data in ROM 23. ROM 23 may be not rewritable.

RAM 25 is a main memory of CPU 21. RAM 25 is used to store necessary data when CPU 21 executes control program 23a.

CPU 21 executes a control program 23a stored in ROM 23 and a control program (not illustrated) stored in RAM 25 or HDD 15. Therefore, CPU 21 controls various operations of image forming device 1. CPU 21 executes control program 23a when the manipulation signal is transmitted from manipulation unit 11 or when the manipulation command is transmitted from PC 401. Therefore, a predetermined function of image forming device 1 is performed according to manipulation unit 11 manipulated by the user.

As described above, scanner 40 performs the scanner function to read the image data from the manuscript. The image data read by the scanner 40 is converted into a predetermined data format by CPU 21, and stored in HDD 15. CPU 21 can transmit the image data stored in HDD 15 to PC 401 or the like.

Under the control of CPU 21, display controller 16 controls a content of information displayed on display panel 13.

When stop key 11b is pressed to receive the stop request, stopping instruction unit 17 performs control to stop a predetermined job in the active jobs. Stopping instruction unit 17 performs the control under the control of CPU 21.

### [Configuration of Server 601]

Referring to FIG. 3, server 601 includes a controller 620 and an HDD 615. Controller 620 includes a CPU (not illustrated), a ROM (not illustrated), and a RAM (not illustrated), and controls server 601.

A control program (not illustrated) of server 601 and various pieces of information are stored in HDD 615. Controller 620 controls server 601 based on the control program, thereby performing the Web server function and other functions of server 601. Server 601 can perform the function as the Web server function and a function as a file server. Server 601 can perform a function as a transmission server of an electronic mail and a function of transmitting the image through the facsimile.

In this embodiment, an authentication database (DB) 615a used for the user authentication is stored in HDD 615. Information on the user to whom the user authentication can be performed and authentication information necessary to authenticate the user are recorded in authentication database 615a while being correlated with each other. For example, the authentication information is a password that is set in each user. Information on the function that can be performed with respect to each user is recorded in authentication database 615a while being correlated with the user.

[Operation Cooperating with Server 601]

In image forming system 900, various server cooperation jobs can be performed by using image forming device 1 and server 601. The server cooperation job is one in which processing is performed in not only image forming device 1 but also server 601. Examples of the processing performed by server 601 include image processing, processing of transmitting authentication data, and processing of transmitting image data. In the embodiment, a searchable PDF (Portable Document Format) file generating job and a user authentication job can be performed as the server cooperation job.

The searchable PDF file generating job is one that generates data of a predetermined file format (PDF) to which text data corresponding to the image read by image forming device 1 is given. A content of the given text data is determined based on a character recognition result such as a character recognition function (OCR (Optical Character Reader) function). That is, the job is associated with the image processing. The generated searchable PDF file is one that includes the text data obtained through the image processing.

At this point, because the character recognition involves a large amount of calculation processing, a processing time is lengthened when image forming device 1 performs the character recognition. Therefore, the image read by image forming device 1 is temporarily transmitted to server 601 in order to perform the character recognition processing by server 601. Server 601 performs the character recognition processing, and generates the searchable PDF file based on the result of the character recognition processing. The generated searchable PDF file is transmitted to image forming device 1, and stored in a predetermined storage area (hereinafter sometimes referred to as a BOX) provided in HDD 15. Therefore, the searchable PDF file generating job ends relatively quickly.

A user authentication job is one that identifies and authenticates the user who uses image forming device 1 or image forming system 900. The user authentication job is performed through image forming device 1. After authenticated through the user authentication job, the user logs into image forming device 1 to be able to use image forming device 1 or image forming system 900.

Authentication database 615a of server 601 is used in the user authentication job. The user authentication job is one that is associated with authentication data transmission processing between image forming device 1 and server 601. For example, the user authentication job is performed as follows. That is, a user authentication screen is presented to the user. The user authentication screen is displayed to display panel 13. The user manipulates manipulation unit 11 to input user information (such as an account name) and the password to image forming device 1. When these pieces of information are input to manipulation unit 11, CPU 21 transmits the input pieces of data to server 601. In server 601, controller 620 refers to authentication database 615a to determine whether the user is authenticated based on the received pieces of data. When the user is authenticated, server 601 determines that the user is authenticated, and transmits an authentication result to image forming device 1. Image forming device 1 receives the authentication result to enable the function, which can be performed with respect to the authenticated user, to be performed. At this point, the authenticated user logs in to image forming device 1. Therefore, image forming device 1 can identify the user who uses image forming device 1.

Performing the user authentication job and identifying a user, the display of display panel 13 and the utilizable function are adapted to the authenticated user to enhance the convenience of image forming device 1. A high security effect is obtained by the use of the user authentication function such that, when the authenticated user exists near image forming device 1, a printed matter is output.

In image forming device 1, CPU 21 performs management relating to use authority of the user with respect to the function of image forming device 1 according to the identified user identified by the user authentication. The use of a predetermined function can be restricted in each user by performing the authority management, and the high security effect is obtained.

The user authentication method is not limited to the above method, but a well-known method can properly be adopted. The reference database of the authentication information or the subject that performs the authentication may be different from those of the first embodiment.

For example, image forming device 1 may possess the authentication information for performing the user authentication. In this case, image forming device 1 can receive an authentication request from the user, and authenticate the user based on the authentication information. For example, a card authentication method in which a contact or non-contact ID card is used or a biometric authentication method in which fingerprint information or venous information on the user is utilized may be adopted, and the user does not need to input the information on the account name or the password.

A job associated with the image data transmission processing may be performed as the server cooperation job. A pull print job is cited as an example of the server cooperation job. In the pull print job, the image data used to form the image is transmitted from server 601 to image forming device 1. Image forming device 1 forms the image based on the received image data.

### [Description of Jobs Performed by Image Forming Device 1]

For example, the following jobs can be performed by image forming device 1. That is, a print job, a copy job, a scan job, a facsimile transmission job, a network facsimile transmission job, an FTP transmission job, and an electronic mail transmission job are performed by image forming device 1. The above jobs are cited only by way of example, and it is acceptable that image forming device 1 cannot perform one of the jobs. Image forming device 1 may perform a different kind of job.

In the print job, printer 30 forms the image in the sheet. The image is formed based on the image data transmitted from PC 401 or the image data stored in image forming device 1.

In the copy job, scanner 40 reads the document to generate the image data, and printer 30 forms the image in the sheet based on the generated image data.

In the scan job, scanner 40 reads the document to generate the image data. The generated image data is stored in a storage device of image forming device 1 or an external storage device. For example, the image data is stored in the BOX of image forming device 1 or an external file server with which image forming device 1 can conduct communication.

In the facsimile transmission job, the facsimile transmission operation is performed through an audio line or a digital line. For example, image forming device 1 can perform the facsimile transmission operation in accordance with a G3 standard. Hereinafter sometimes referred to as a G3 fax transmission job on behalf of the facsimile transmission job. Instead of the G3 standard, image forming device 1 may perform the facsimile transmission operation in accordance with other standards, such as a super G3 standard and a G4 standard. In the facsimile transmission job, for example, the image data that is generated by reading the document with scanner 40 or the image data stored in the BOX can be transmitted.

In the network facsimile transmission job, for example, the image data is transmitted through an IP (Internet Protocol) network by what is called an Internet FAX. In the network facsimile transmission job, for example, the image data that is generated by reading the document with scanner 40 or the image data stored in the BOX can be transmitted. It can be said that the network facsimile transmission job is one of the facsimile transmission jobs from the viewpoint of performing the facsimile transmission.

In the FTP transmission job, a file transfer operation is performed. In the FTP transmission job, the image data that is generated by reading the document with scanner 40 or the image data stored in the BOX is transmitted by use of the FTP.

In the electronic mail transmission job, the image data is transmitted while attached to an electronic mail. In the electronic mail transmission job, the image data that is generated by reading the document with scanner 40 or the image data stored in the BOX can be transmitted.

In addition to the above jobs, the searchable PDF file generating job and the user authentication job are cited as the server cooperation job.

In some of the jobs, sheet conveying unit 31 or automatic document conveying unit 41 (hereinafter sometimes collectively referred to as conveying units 31 and 41) performs a sheet conveying operation.

That is, in the print job and the copy job, sheet conveying unit 31 performs the sheet conveying operation. When processing of forming the image after the user authentication is performed as the user authentication job (for example, when what is called the pull print is performed), sometimes sheet conveying unit 31 conveys the sheet in forming the image.

In the copy job, the scan job, the facsimile transmission job, the network facsimile transmission job, the FTP transmission job, the electronic mail transmission job, and the searchable PDF file generating job, sometimes automatic document conveying unit 41 conveys the sheet when scanner 40 reads the document.

### [Descriptions of Temporarily Stoppable Job and Disposable Job]

The job is classified into a job that can temporarily be stopped while being performed (hereinafter sometimes simply referred to as stop) and a job that cannot be stopped while being performed. As used herein, the temporary stop means that the operation interrupts so as to be able to be resumed. The job is also classified into a job that can be disposed of while being performed and a job that cannot be disposed of while being performed. The disposal of the job means that the job is stopped so as not to be able to be resumed.

The print job and the copy job are stoppable. For other jobs, when automatic document conveying unit 41 conveys the sheet, the sheet conveying operation is stoppable. For example, when the image forming operation is performed, the image forming operation can be stopped after the image is formed in the conveyed sheet. When the scan operation is performed, the scan operation can be stopped after the document conveyed at that time is read and discharged. In each case, the operation can be resumed from the next sheet. Thus, in the jobs performed by image forming device 1, the job (a first kind of job) in which conveying units 31 and 41 perform the sheet conveying operation is stoppable. In other words, the reading operation and printing operation are the stoppable operations.

In the embodiment, in the jobs except the job in which the sheet conveying operation is performed, for example, the network facsimile transmission job is stoppable according to timing. Alternatively the network facsimile transmission job may belong to the following unstoppable job.

The facsimile transmission job, the FTP transmission job, the electronic mail transmission job, and the scan job are jobs, which cannot be stopped when automatic document conveying unit 41 does not convey the sheet while the jobs are performed by image forming device 1. That is, in the jobs, the information is transmitted by each method according to a procedure of communication with a device that is of the other side. Therefore, once the transmission is stopped, the transmission cannot be resumed. Accordingly, the jobs are unstoppable. The same holds true for the case that the information is stored in a storage device. In the jobs, the job may be stopped during the communication.

The job in the unstoppable state includes the active server cooperation job in which communication is conducted with server 601. In the server cooperation job, not only the job in which communication is conducted between image forming device 1 and server 601 but also the job in which server 601 currently performs processing cannot be stopped by image forming device 1.

Almost all the above jobs are disposable during the performance. That is, the stoppable job is disposable. The job in which image forming device 1 currently conducts communication with another device and the job in which the information is stored in the storage device are also disposable.

The server cooperation job that is currently performed by server 601 is not disposable. For example, when the character recognition processing or the user authentication processing are currently performed by server 601, image forming device 1 cannot involve the character recognition processing or the user authentication processing. Therefore, the job in this state is not disposable.

Thus, the jobs that are currently performed by image forming device 1 can be classified into three kinds. That is, there is the job (hereinafter sometimes referred to as a stoppable job) that is stoppable and disposable according to the state. There is also the job (hereinafter sometimes referred to as an unstoppable job) that is disposable while being unstoppable. There is also the job (hereinafter sometimes referred to as an indisposable job) that is unstoppable and indisposable.

[Description of Operation when Stop Key 11b is Pressed]

In image forming device 1 of the embodiment, CPU 21 repeatedly performs the following control while the job is performed. The control is performed by using display controller 16 and stopping instruction unit 17 of image forming device 1.

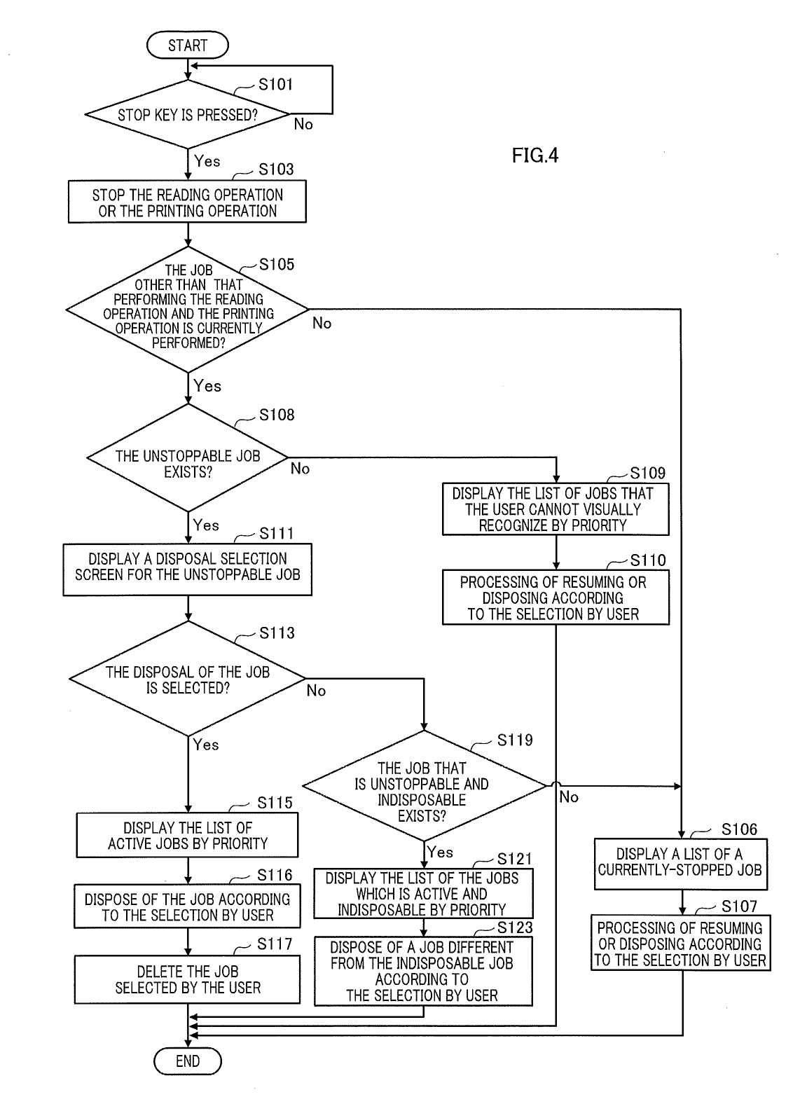

FIG. 4 is a flowchart illustrating an operation of image forming device 1.

As illustrated in FIG. 4, in Step S101, CPU 21 determines whether slop key 11b is pressed. CPU 21 receives the stop request to stop the job, which is currently performed by image forming device 1, from the user. When stop key 11b is pressed, CPU 21 detects the press of stop key 11b to go to a next step.

When stop key 11b is pressed in Step S101, CPU 21 stops the reading operation or the printing operation in Step S103. CPU 21 can cause stopping instruction unit 17 to stop the reading operation and the printing operation. In other words, under the control of CPU 21, stopping instruction unit 17 stops the stoppable job, in which conveying units 31 and 41 perform the sheet conveying operation, in the jobs that are currently performed by image forming device 1. When the stoppable job does not exist, CPU 21 may go to the next step.

When a stoppable job that is not associated with the sheet conveying operation exists, the job is stopped in Step S101.

In Step S105, CPU 21 determines whether the job other than that performing the reading operation and the printing operation is currently performed. For example, the determination is made by using display controller 16.

When the job other than that performing the reading operation and the printing operation does not exist in Step S105, CPU 21 displays the information on the currently-stopped job to the user in Step S106.

For example, the information on the job is displayed under the control of display controller 16 such that the pieces of information on the jobs that are of display targets are listed on display panel 13. The same holds true for the following description.

When the display is performed in Step S106, CPU 21 receives a user manipulation to select whether the job in which the information is displayed is resumed or disposed of in Step S107. For example, when the user manipulates a predetermined manipulation key displayed on display panel 13, CPU 21 receives the manipulation. CPU 21 performs processing of resuming or disposing of the corresponding job in response to the received manipulation. The job in which the disposal is selected is deleted.

On the other hand, when the currently-performed job, such as the facsimile transmission job, exists in Step S105, CPU 21 determines whether the job that cannot be stopped exists in Step S108. In other words, CPU 21 determines whether the job that is not stoppable but unstoppable (an example of the second kind of job) exists in the jobs that are currently performed by image forming device 1. The unstoppable job and the indisposable job correspond to the job that cannot be stopped.

When the job that cannot be stopped does not exist in Step S108, CPU 21 displays the information on the job that can be stopped in Step S109. At this point, CPU 21 displays the job, in which the reading operation and the printing operation are not performed, in priority to other jobs under the control of display controller 16. That is, the job displayed on a priority basis is one in which the user cannot visually recognize whether the job is currently performed or stopped. The list of the jobs that the user cannot visually recognize is displayed to the user. For example, when the network facsimile transmission job is stopped by pressing stop key 11b during the transmission processing, the information on the network facsimile transmission job is displayed in priority to other jobs (such as the print job and the copy job) that are stopped.

In Step S110, CPU 21 performs the same processing as Step S107. That is, CPU 21 receives the user manipulation to select whether the job in which the information is displayed is resumed or disposed of, and performs the processing of resuming or disposing of the job. The job in which the disposal is selected is deleted.

When the job that cannot be stopped in Step S108, CPU 21 displays a disposal selection screen in which whether the job that cannot be stopped is disposed of in Step S111. The disposal selection screen is displayed on display panel 13 under the control of display controller 16. The user performs the selection manipulation on the disposal selection screen to be able to issue an instruction whether the job is disposed of to image forming device 1.

In Step S113, CPU 21 determines whether the disposal of the job is selected.

When the disposal of the job is selected in Step S113, CPU 21 displays the information on the active job in Step S115. Under the control of display controller 16, the list of the jobs that cannot be stopped is displayed on display panel 13. The user can select the disposal of the job by manipulating the list displayed on display panel 13. At this point, CPU 21 displays the active job in priority to other jobs under the control of display controller 16.

In Step S116, CPU 21 receives the user manipulation to select the disposal of the job in which the information is displayed. CPU 21 performs the processing of disposing of the job according to the received manipulation.

In Step S117, CPU 21 deletes the job selected by the user in the jobs in which the pieces of information are displayed.

On the other hand, when the disposal of the job is not selected in Step S113, CPU 21 determines whether the indisposable job exists in Step S119.

When the indisposable job does not exist in Step S119, CPU 21 performs the pieces of processing in Steps S106 and S107.

When the indisposable job exists in Step S119, CPU 21 displays the information on the indisposable job in Step S121. Under the control of display controller 16, the list of the jobs, which cannot be stopped, including the indisposable job is displayed on display panel 13. At this point, CPU 21 displays the indisposable job in priority to other jobs under the control of display controller 16.

In Step S123, CPU 21 receives an instruction to dispose of a job different from the indisposable job. The user manipulates the list of the indisposable jobs displayed on display panel 13. Therefore, the user can select the disposal of the disposable, for unstoppable job that is currently performed. When the selection of the disposal is received, the processing of disposing of the selected job is performed. The job that is selected as the disposal target is deleted.

A string of pieces of processing is ended after the pieces of processing in Steps S107, S110, S117, and S123.

[Specific Example of Operation when Stop Key 11b is Pressed]

A specific example of the operation will be described. For example, it is assumed that stop key 11b is pressed while the print job transmitted from PC 401, the copy job, the G3 fax transmission job (an example of the facsimile transmission job), and the network facsimile transmission job are performed. At this point, it is assumed that, when stop key 11b is pressed, the printing is currently performed in the print job, the reading is currently performed in the copy job, and the transmission is currently performed in the G3 fax transmission job and the network facsimile transmission job.

When stop key 11b is pressed, the operation is stopped in the stoppable job, namely, the print job and the copy job. At this point, because the unstoppable job exists in the active jobs, the disposal selection screen is displayed (Steps S101 to S111 in FIG. 4).

FIG. 5 is a view illustrating an example of the disposal selection screen that is displayed when stop key 11b is pressed.

As illustrated in FIG. 5, a message display unit 111 and manipulation keys 112 and 113 corresponding to “YES” and “NO” are displayed on a disposal selection screen 110. Information, such as a message indicating “job currently dialed or transmitted is deleted?”, which encourages the user to select whether the job is disposed of is displayed on message display unit 111. Manipulation key 112 is used to select “job is disposed of”, and manipulation key 113 is used to select “job is not disposed of”. The portions corresponding to manipulation keys 112 and 113 are manipulated in disposal selection screen 110 displayed on display panel 13, which allows the user to indicate the intention to image forming device 1.

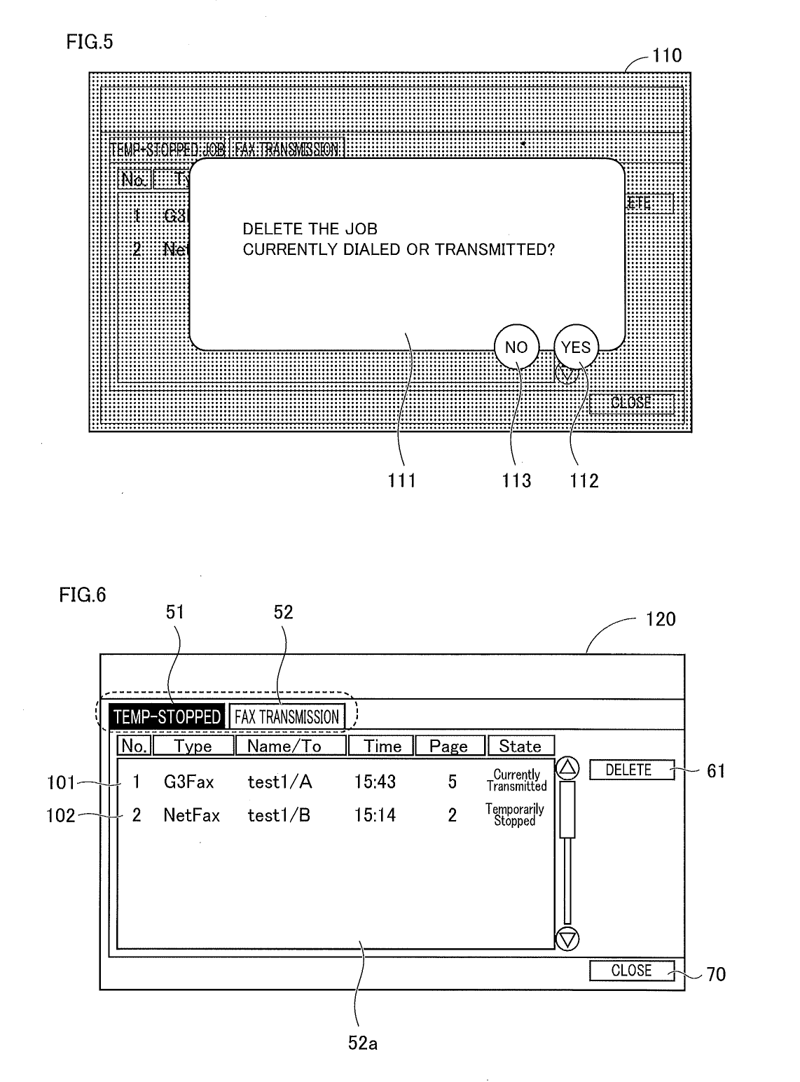

FIG. 6 is a view illustrating an example of the job information display screen for disposing of the job.

A job information display screen 120 is displayed when manipulation key 112 is manipulated on disposal selection screen 110 to select “job is disposed of” (in FIG. 4, YES in Step S113 and S115). That is, job information display screen 120 is displayed when the disposal of the job is selected in the display of disposal selection screen 110.

As illustrated in FIG. 6, job information display screen 120 includes what is called a tab user interface. In job information display screen 120, the information on the job to be displayed is displayed in a display area belonging to each tab. When job information display screen 120 is displayed, the information on the active job that cannot be stopped and the information on the temporarily-stopped job are displayed while divided into plural tabs.

A temporarily-stopped tab 51 and a facsimile transmission tab 52 are displayed on job information display screen 120 (surrounded by a dotted line in FIG. 6). On job information display screen 120, active one of tabs 51 and 52 is indicated by dark characters with a faint background. Inactive one of tabs 51 and 52 is indicated by faint characters with a dark background. In the example illustrated in FIG. 6, temporarily-stopped tab 51 is in the inactive state, and facsimile transmission tab 52 is in the active state.

A portion below tabs 51 and 52 is a display area where the information on the job corresponding to the active tab of tabs 51 and 52 is displayed. A job list 52a including the information on the job belonging to facsimile transmission tab 52 in the active state is displayed in the example illustrated in FIG. 6. The pieces of information on each job, such as a class and a document name of the job, an address, a registration time of the job, the number of pages relating to the transmission, and the state of the job, are displayed in job list 52a. In other words, the information on the job corresponding to facsimile transmission tab 52 is displayed on job information display screen 120 by displaying job list 52a.

Additionally, a delete key 61 used to dispose of the selected job is displayed on job information display screen 120. A manipulation key 70 used to close (hide) job information display screen 120 is also displayed on job information display screen 120.

On job information display screen 120, the pieces of information on jobs 101 and 102, which correspond to the facsimile transmission tab 52 and relate to the facsimile transmission, are listed in job list 52a. That G3 fax transmission job 101 having a class of “G3 Fax” is “currently transmitted” is displayed in facsimile transmission tab 52. That the transmission of network facsimile transmission job 102 having the class of “Net Fax” is “temporarily stopped” is displayed in facsimile transmission tab 52. Thus, the information on the active job that cannot be stopped is displayed by displaying job information display screen 120.

In the job list, basically the pieces of information on the jobs are displayed in the order in which the job is registered. For example, it is assumed that jobs 101 and 102 are registered in this order. In this case, jobs 101 and 102 are displayed in job list 52a such that job 101 is located above job 102. In the job list, the job displaying order may be changed with an arbitrary item assigned by the user as a sort key.

In the embodiment, the information on the active job that cannot be stopped is displayed on job information display screen 120 in priority to other pieces of information, such as the information on the temporarily-stopped job and the waiting (before start) job.

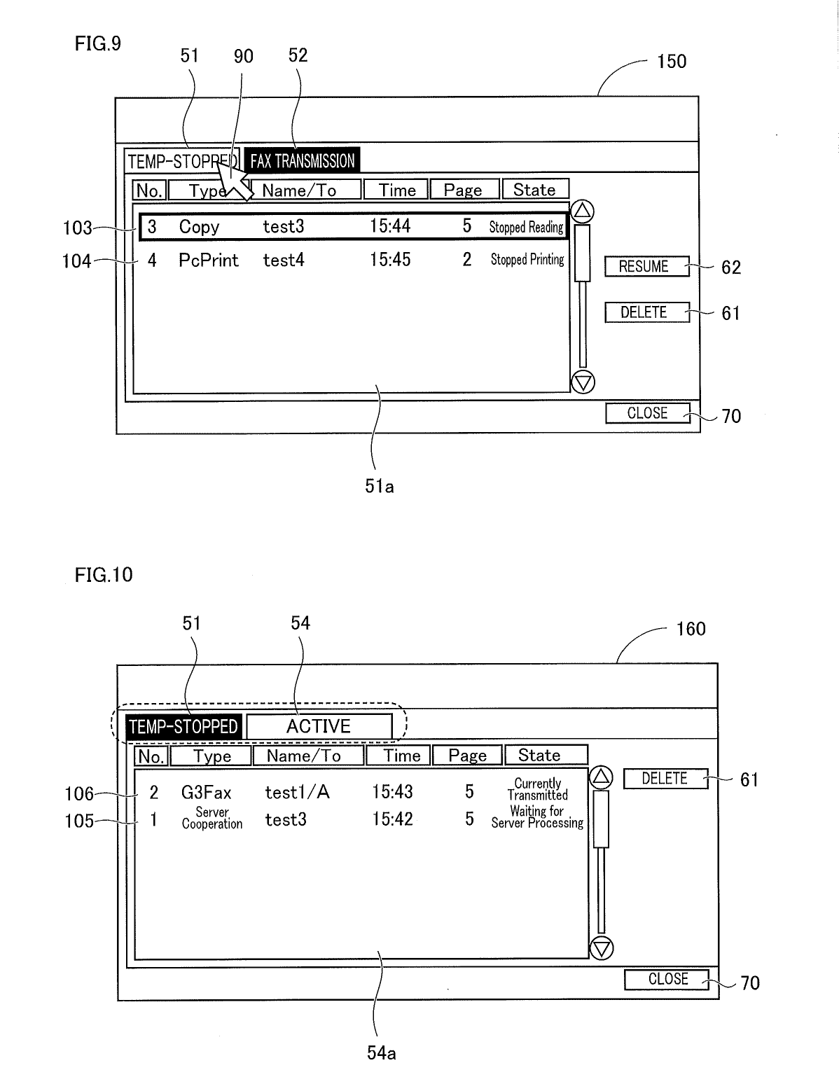

When job information display screen 120 is displayed, the temporarily-stopped job corresponds to job list 51a, which is displayed while temporarily-stopped tab 51 is selected as illustrated in FIG. 9. On the other hand, the active job that cannot be stopped corresponds to job list 52a, which is displayed while facsimile transmission tab 52 is selected. When the disposal of the job is selected on the disposal selection screen 110, CPU 21 displays job information display screen 120 while putting facsimile transmission tab 52 into the active state in priority to temporarily-stopped tab 51 in the two tabs 51 and 52. Therefore, the information on the active job is displayed on the screen on a priority basis. Accordingly, the user can quickly and surely recognize the information on the active job.

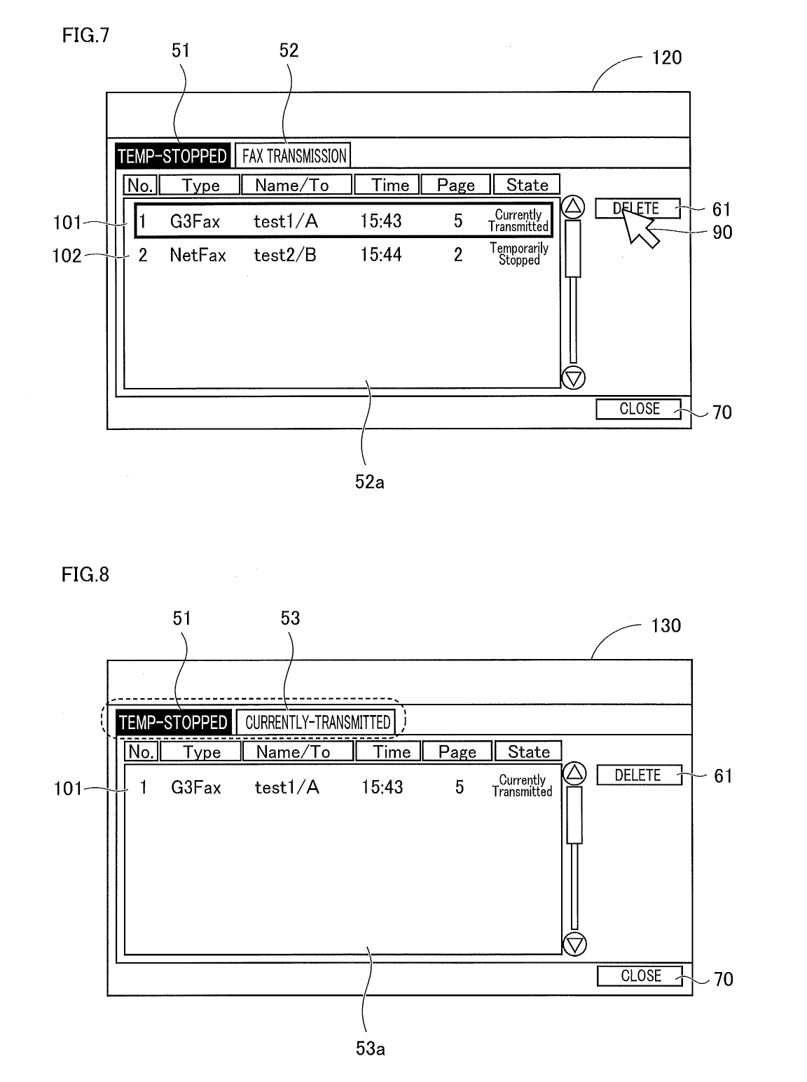

FIG. 7 is a view illustrating an example of the selection manipulation for disposing of the job.

While job information display screen 120 is displayed, the user selects jobs 101 and 102 displayed in facsimile transmission tab 52, and performs the disposal manipulation. Therefore, the user can issue an instruction to dispose of the selected job. In response to the disposal instruction from the user, CPU 21 disposes of the job that is of the target of the disposal instruction, and deletes the job from facsimile transmission tab 52 (in FIG. 4, Steps S116 and S117).

For example, it is assumed that the user disposes of G3 fax transmission job 101 in jobs 101 and 102. At this point, the user selects G3 fax transmission job 101 in facsimile transmission tab 52. As illustrated in FIG. 7, when job 101 is selected, the portion in which the information on job 101 is displayed is indicated on the screen while surrounded by a rectangular shape. Therefore, the user can recognize that job 101 is selected. Then the user performs the manipulation to select delete key 61 with job 101 selected (presses delete key 61). The processing of disposing of selected job 101 is performed by manipulating delete key 61. Alternatively, plural jobs (for example, both jobs 101 and 102) may be selected as the processing target.

For example, the job selecting manipulation or the manipulation-key selecting manipulation can be performed such that the user touches the portion in which the job or the manipulation key is displayed on display panel 13 by a user's finger. At this point, as illustrated in FIG. 7, an image of a cursor 90 is displayed in a region in which the selection manipulation is performed such that the performance of the selection manipulation is displayed. Alternatively, the selection manipulation may be performed such that the selection key is pressed while cursor 90 is moved to a position that is of the selection target using a cursor key or a selection key, which is provided in manipulation key 11a. Alternatively, the selection manipulation may be performed such that cursor 90 is moved on job information display screen 120 using a pointing device, which is provided so as to be able to be used by image forming device 1.

FIG. 8 is a view illustrating another example of the job information display screen.

The following job information display screen 130 may be displayed when “job is disposed or is selected on disposal selection screen 110. As illustrated in FIG. 8, in job information display screen 130, the information on the job is displayed in one of” temporarily-stopped tab 51 and a currently-transmitted tab 53.

In job information display screen 130, the tab in which the job is displayed based on whether the job is temporarily stopped. CPU 21 displays job information display screen 130 while putting facsimile currently-transmitted tab 53 into the active state in priority to temporarily-stopped tab 51. In other words, both the information on the active job that cannot be stopped and the information on the temporarily-stopped job are displayed on job information display screen 130. At this point, the information on the active job that cannot be stopped is displayed in priority to the information on the temporarily-stopped job.

The information on G3 fax transmission job 101, which is not able to be stopped but currently transmitted, is displayed in currently-transmitted tab 53. Other jobs are stopped by pressing stop key 11b. Therefore, the pieces of information on other jobs are displayed in not currently-transmitted tab 53 but temporarily-stopped tab 51.

Currently-transmitted tab 53 becomes active when job information display screen 130 is displayed, so that the user can quickly recognize the information on G3 fax transmission job 101 displayed in currently-transmitted tab 53.

FIG. 9 is a view illustrating an example of the job information display screen on which information on the temporarily-stopped job is displayed.

On job information display screen 120 as displayed above, temporarily-stopped tab 51 that is originally set to the inactive state can be put into the active state based on the manipulation of the user. As illustrated in FIG. 9, the user can put temporarily-stopped tab 51 into the active state such that temporarily-stopped tab 51 is selected by the manipulation on the screen of display panel 13 or another manipulation. At this point, facsimile transmission tab 52 that is in the active state until then becomes inactive instead of temporarily-stopped tab 51 that becomes active. On job information display screen 130, temporarily-stopped tab 51 can be put into active state in the same manner.

On job information display screen 150 in which temporarily-stopped tab 51 is active, the pieces of information on temporarily-stopped jobs 103 and 104 are displayed in job list 51a of temporarily-stopped tabs 51. For example, “reading is stopped” with respect to a copy job 103, and the information on “reading is stopped” are displayed. For example, “printing is stopped” with respect to a print job 104, and the information on “printing is stopped” is displayed. Because the pieces of information on jobs 103 and 104 that can be resumed are displayed on job information display screen 150, a resume key 62 is displayed in addition to delete key 61.

On job information display screen 150, the user can dispose of selected jobs 103 and 104 such that the manipulation to select delete key 61 is performed while jobs 103 and 104 that are of the processing targets are selected. The user can resume the operations of selected jobs 103 and 104 such that the manipulation to select resume key 62 is performed while jobs 103 and 104 that are of the processing targets are selected.

At this point, when the user does not select “job is disposed of” while disposal selection screen 110 is displayed, CPU 21 displays a job information display screen 150 (in FIG. 4, NO in Step S113, NO in Step S119, and Step S106). That is, when manipulation key 113 corresponding to “NO” is selected while disposal selection screen 110 is displayed, CPU 21 displays job information display screen 150. The information on the temporarily-stopped job, in which the user possibly issues the instruction, is displayed to the user who does not intend to issue the instruction to dispose of the active job. The user can quickly perform the manipulation to select the temporarily-stopped job by displaying the information on the job having a relatively high probability that the job becomes manipulation target. The number of times of the manipulations that the user should perform can be decreased.

In the case that only one unstoppable job exists, such as the case that the transmission is currently performed only in one facsimile transmission job, when stop key 11b is pressed, a different control operation may be performed. In this case, when the manipulation to select the disposal of the job is performed on disposal selection screen 110, the job may be disposed of without listing the pieces of information on the jobs on the job information display screen. Therefore, the user can quickly and easily dispose of the job without performing the manipulation to dispose of the job on the job information display screen.

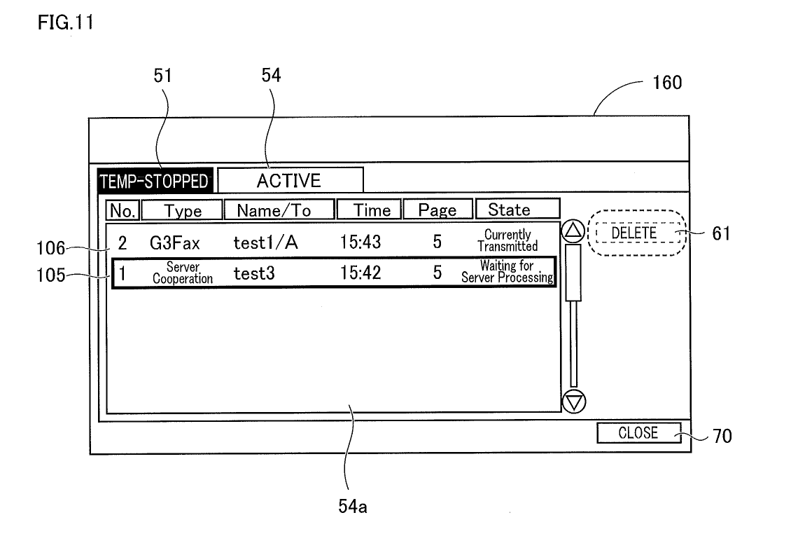

FIG. 10 is a view illustrating an example of the job information display screen when the server cooperation job is currently performed.

In the specific example, it is assumed that the server cooperation job is currently performed when stop key 11b is pressed. At this point, when the disposal of the job is selected on disposal selection screen 110, a job information display screen 160 is displayed as illustrated in FIG. 10.

Job information display screen 160 differs from job information display screen 130 in that an active tab 54 is displayed instead of currently-transmitted tab 53. Similarly to job information display screen 130, temporarily-stopped tab 51 and delete key 61 are displayed.

In the embodiment, a G3 fax transmission job 106 and a server cooperation job 105 are the active jobs when stop key 11b is pressed. Therefore, jobs 105 and 106 are displayed as job list 54a in active tab 54. Because other jobs are stopped by pressing stop key 11b, other jobs are displayed in temporarily-stopped tab 51. The information on the active job and the information on the temporarily-stopped job are displayed on job information display screen 160; however, active tab 54 is displayed on job information display screen 160 in priority to temporarily-stopped tab 51. That is, when job information display screen 160 is displayed, active tab 54 becomes active while temporarily-stopped tab 51 becomes inactive.

When job information display screen 160 is displayed, the user can select G3 fax transmission job 106 to issue the disposal instruction. Therefore, the processing of disposing of G3 fax transmission job 106 is performed.

It is assumed that server cooperation job 105 is currently processed by server 601 when job information display screen 160 is displayed. At this point, server cooperation job 105 is the indisposable job that can be neither stopped nor disposed of. Irrespective of the job registration order, server cooperation job 105 is displayed in the same job list while having a lower priority than other disposable jobs. That is, when the indisposable job that can be neither stopped nor disposed of exists, CPU 21 displays the information on the indisposable job in priority to the information on the temporarily-stopped job. CPU 21 displays the information on the indisposable job to the user while not placing the priority to the indisposable job compared with the information on the disposable job that cannot be stopped.

For example, when jobs 105 and 106 are displayed in job list 54a as illustrated in FIG. 10, even if server cooperation job 105 is registered in advance of G3 fax transmission job 106, G3 fax transmission job 106 is displayed so as to be located above server cooperation job 105. That is, G3 fax transmission job 106 is displayed in priority to server cooperation job 105. At this point, CPU 21 does not receive the manipulation performed to delete key 61, even if server cooperation job 105 is selected on job information display screen 160. FIG. 11 is a view illustrating a display example when the server cooperation job currently processed by server 601 is selected on job information display screen 160.

As described above, when server cooperation job 105 is currently processed by server 601 while job information display screen 130 is displayed, CPU 21 changes the display of delete key 61. When the display of delete key 61 is changed, the user who sees the change of the display of delete key 61 can intuitively and easily recognize that the disposal instruction cannot be issued with respect to server cooperation job 105. Accordingly, the user can prevent the useless manipulation.

The display of delete key 61 may be changed by hiding delete key 61 as illustrated in FIG. 11. As to the display color of delete key 61, the display mode of delete key 61 may be changed from manipulatable state by reducing a shade or lowering brightness or saturation.

### [Description of Specific Example of Active Operation of Server Cooperation Job]

A specific example of the operation, which is performed when stop key 11b is pressed during the searchable PDF file generating job or the user authentication job in the server cooperation job, will be described below.

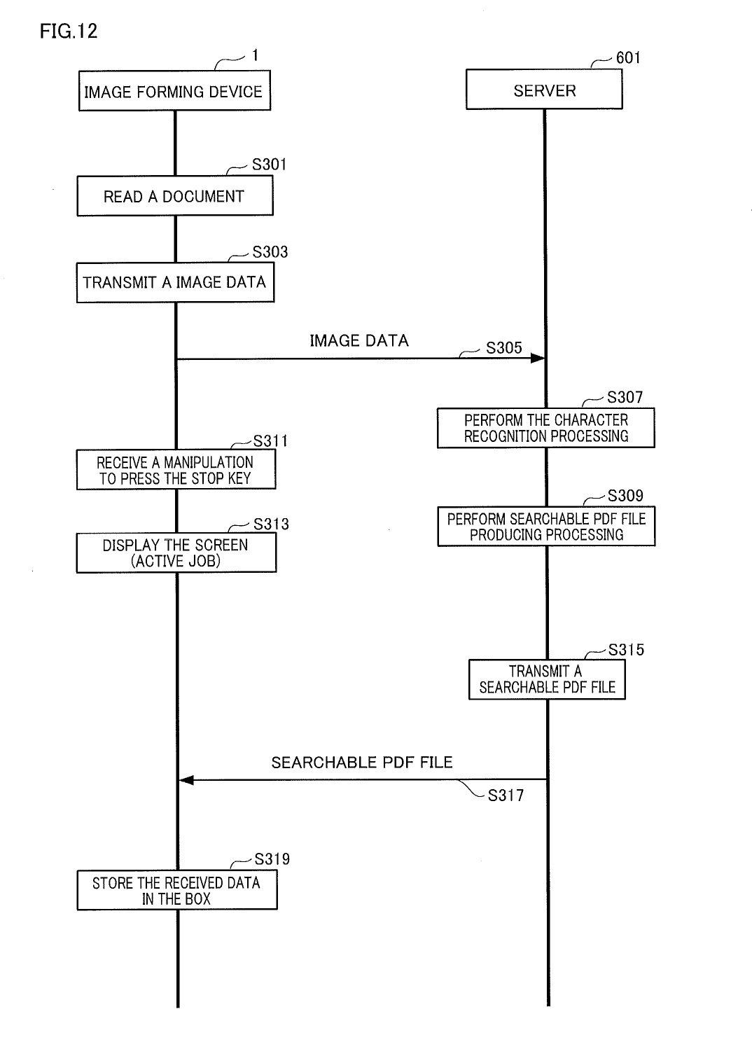

FIG. 12 is a sequence diagram illustrating a procedure of the searchable PDF file generating job.

As illustrated in FIG. 12, the searchable PDF file generating job (hereinafter sometimes simply referred to as a generation job) is performed between image forming device 1 and server 601. The processing is performed by image forming device 1 such that each unit of image forming device 1 is operated under the control of CPU 21. The operation is performed by server 601 such that each unit of server 601 is operated under the control of controller 620.

When the searchable PDF file generating job is started, image forming device 1 reads the document in Step S301.

In Step S303, image forming device 1 transmits the image data, which is generated by reading the document, to server 601.

In Step S305, the image data is transmitted from image forming device 1 to server 601 through network 800.

In Step S307, server 601 performs the character recognition processing to the transmitted image data.

In Step S309, server 601 performs searchable PDF file producing processing based on a result of the character recognition processing and the image data. Therefore, the image data is converted into the searchable PDF file.

At this point, it is assumed that stop key 11b is pressed in image forming device 1 while the pieces of processing in Steps S307 and S309 are performed by server 601. In Step S311, image forming device 1 receives the manipulation to press stop key 11b.

For example, a period during which image forming device 1 cannot dispose of the job when stop key 11b is pressed may be set to one until the searchable PDF file transmitted from server 601 is received since the image data is transmitted to server 601 (Steps S305 to S317).

When the manipulation to press stop key 11b is received in Step S311, image forming device 1 displays the screen relating to the active job in Step S313. When the manipulation to press stop key 11b is received in Step S311, server 601 currently performs the searchable PDF file generating job. Accordingly, for example, the job information display screen illustrated in FIG. 10 or 11 is displayed subsequent to the disposal selection screen. The information on the server cooperation job, which indicates that the server cooperation job is currently processed by the server, is displayed on the job information display screen.

When the searchable PDF file is completed in Step S309, server 601 transmits the completed searchable PDF file to the image forming device 1 in Step S315.

In Step S317, the data of the searchable PDF file is transmitted from server 601 to image forming device 1 through network 800.

In Step S319, for example, image forming device 1 stores the received data of the searchable PDF file in the BOX. Image forming device 1 ends the searchable PDF file generating job. Image forming device 1 may transmit the received file to an external device, such as PC 401, by electronic mail by a setting or an instruction from the user.

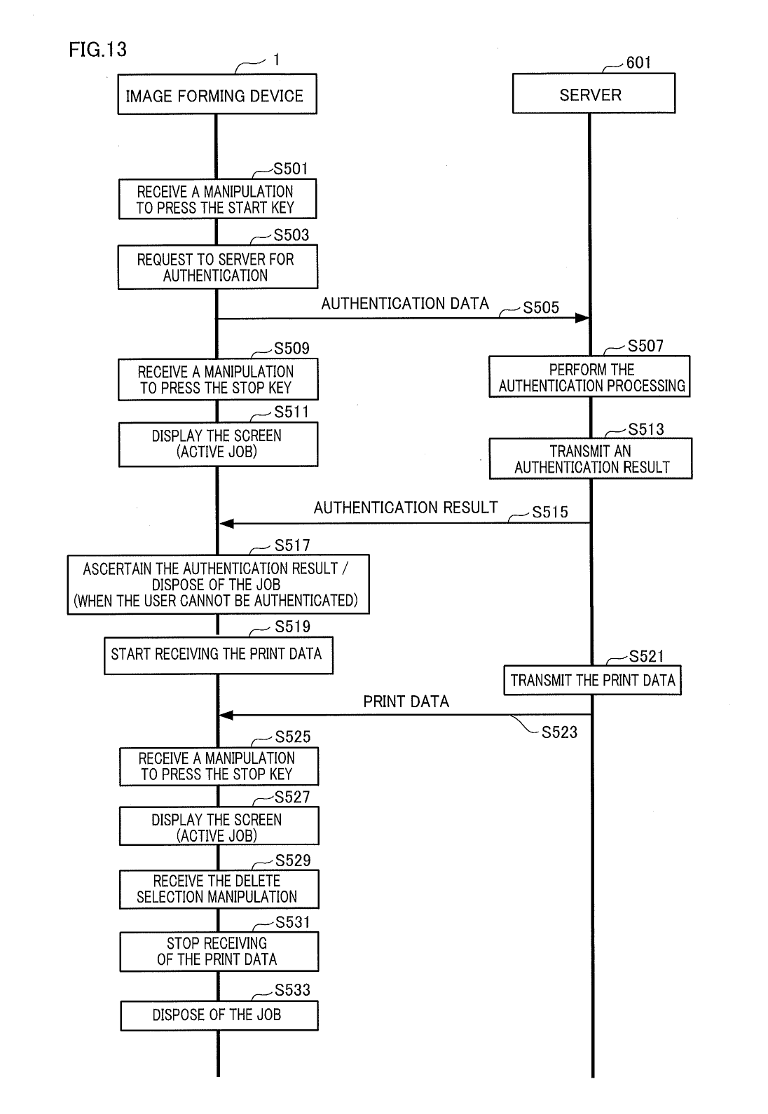

FIG. 13 is a sequence diagram illustrating a procedure of the authentication pull print job in which server 601 is used.

The authentication pull print job is performed while the user authentication job and the pull print job are combined. As illustrated in FIG. 13, the authentication pull print job is performed between image forming device 1 and server 601. The processing is performed by image forming device 1 such that each unit of image forming device 1 is operated under the control of CPU 21. The operation is performed by server 601 such that each unit of server 601 is operated under the control of controller 620.

For example, the authentication pull print job is started such that the user issues a performance instruction to image forming device 1. In Step S501, image forming device 1 receives the user manipulation of manipulation unit 11 (for example, the manipulation to press the start key (not illustrated)). When the manipulation of manipulation unit 11 is received, the authentication pull print job is started.

In Step S503, image forming device 1 makes a request to server 601 for the authentication. For example, image forming device 1 transmits authentication data including previously-received information on the user and a password of the user to server 601. Image forming device 1 makes the request to server 601 for the performance of the authentication processing.

In Step S505, the authentication data is transmitted from image forming device 1 to server 601 through network 800.

In Step S507, server 601 performs the authentication processing to the transmitted authentication data. As described above, the authentication processing is performed by referring to authentication database 615a.

At this point, it is assumed that stop key 11b is pressed in image forming device 1 while the processing in Step S507 is performed by server 601. In Step S509, image forming device 1 receives the manipulation to press stop key 11b.

When the manipulation to press stop key 11b is received in Step S509, image forming device 1 displays the screen relating to the active job in Step S511. When the manipulation to press stop key 11b is received in Step S509, server 601 currently performs the authentication pull print job. Accordingly, for example, the following job information display screen is displayed subsequent to the disposal selection screen.

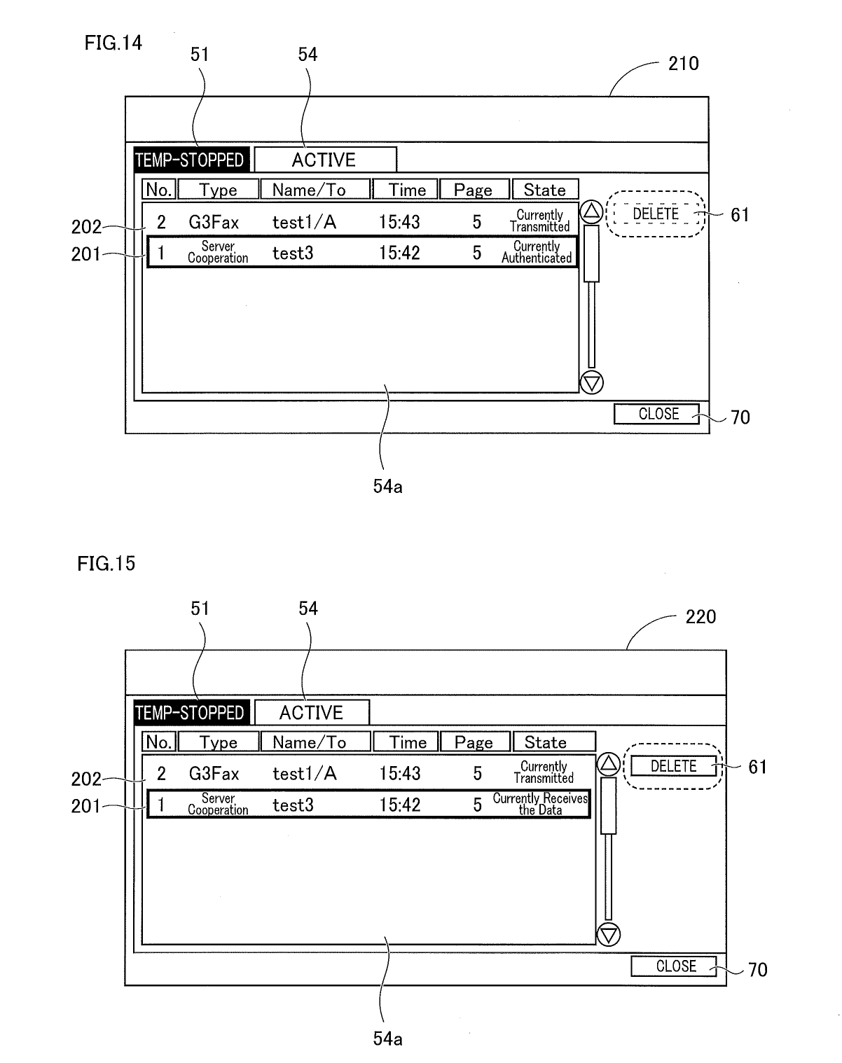

FIG. 14 is a view illustrating an example of the job information display screen that is displayed after stop key 11b is pressed.

As illustrated in FIG. 14, active tab 54 is displayed on a job information display screen 210 in priority to temporarily-stopped tab 51. Information on an authentication pull print job 201 is displayed in job list 54a of active tab 54. In the example illustrated in FIG. 14, for example, information on a G3 fax transmission job 202 that is performed at that time is displayed in job list 54a along with authentication pull print job 201. Because authentication pull print job 201 is the indisposable job, G3 fax transmission job 202 is displayed in priority to authentication pull print job 201.

At this point, that authentication pull print job 201 is “currently authenticated”, namely, processed by server 601 is displayed in job list 54a as illustrated in FIG. 14. When authentication pull print job 201 is selected, delete key 61 is hidden because authentication pull print job 201 is the indisposable job.

For example, the period during which image forming device 1 cannot dispose of the job when stop key 11b is pressed may be set to one until the authentication result is received from server 601 since the authentication data is transmitted to server 601 (Steps S505 to S515).

Referring to FIG. 13, when the authentication processing is ended, an authentication result is transmitted to image forming device 1 in Step S513.

In Step S515, the authentication result is transmitted from server 601 to image forming device 1 through network 800.

In Step S517, image forming device 1 ascertains the received authentication result to determine whether image forming device 1 can perform the pull print with respect to the user, namely, whether the user can be authenticated. When the user cannot be authenticated, the authentication pull print job is disposed of because the pull print cannot be performed.

When the user is authenticated in Step S517, image forming device 1 starts to receive the print data used for the pull print in Step S519.

In Step S521, server 601 transmits the print data that is of the pull print target to image forming device 1.

In Step S523, the print data is transmitted from server 601 to image forming device 1 through network 800.

At this point, it is assumed that stop key 11b is pressed in image forming device 1 while the processing in Step S523 is performed between server 601 and image forming device 1. In Step S525, image forming device 1 receives the manipulation to press stop key 11b.

When the manipulation to press stop key 11b is received in Step S525, image forming device 1 displays the screen relating to the active job in Step S527. When the manipulation to press stop key 11b is received in Step S525, image forming device 1 currently receives the print data of the authentication pull print job transmitted from server 601. At this point, for example, the following job information display screen is displayed subsequent to the disposal selection screen.

FIG. 15 is a view illustrating an example of the job information display screen that is displayed after stop key 11b is pressed.

As illustrated in FIG. 15, roughly the pieces of information on jobs 201 and 202 are displayed on a job information display screen 220 in the same mode as job information display screen 210.

As illustrated in FIG. 15, that authentication pull print job 201 “currently receives the data”, namely, currently performs the processing of receiving the print data from server 601 is displayed in job list 54a. When the print data is currently received, authentication pull print job 201 is in the state in which authentication pull print job 201 can be disposed of while not be stopped. Accordingly, delete key 61 is displayed when authentication pull print job 201 is selected.

The user can delete the authentication pull print job when job information display screen 220 is displayed. Referring to FIG. 13, when job information display screen 220 is displayed in Step S527, image forming device 1 receives the delete selection manipulation from the user in Step S529.

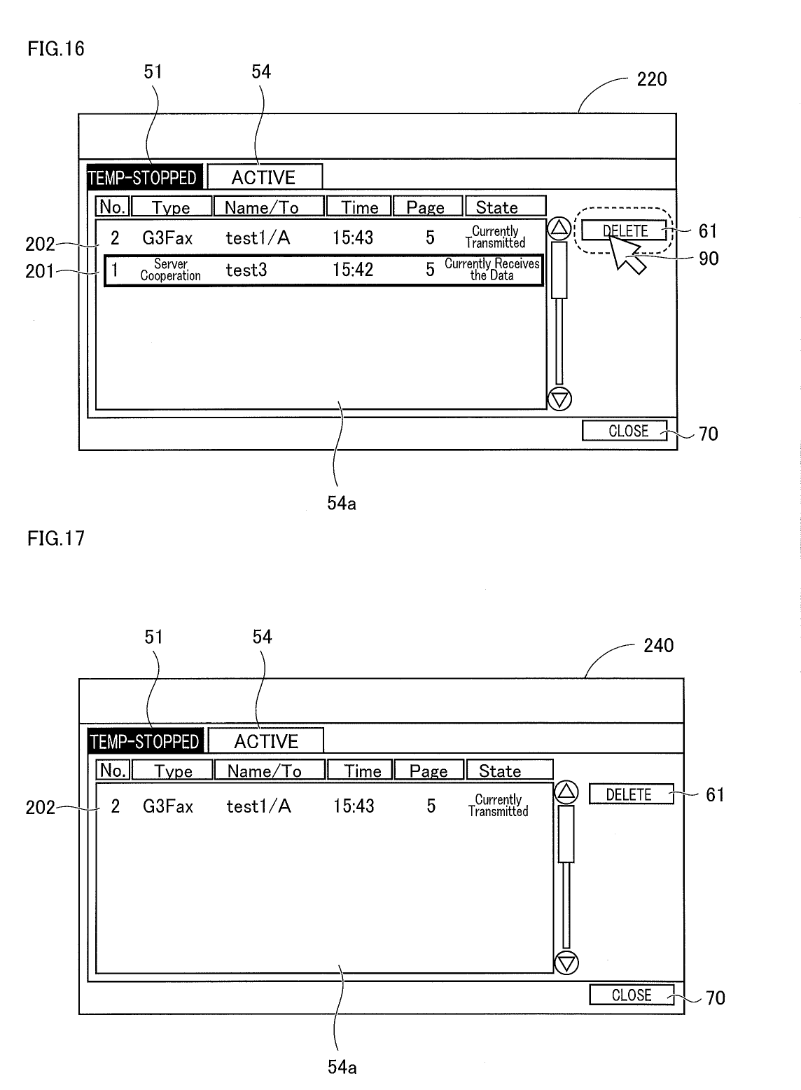

FIG. 16 is a view illustrating an example of a delete selection manipulation receiving operation on job information display screen 220.

The user selects authentication pull print job 201 in which the “data is currently received” on job information display screen 220. The manipulation to select displayed delete key 61 is performed as illustrated by cursor 90 in FIG. 16. Therefore, the user can perform the delete selection manipulation with respect to authentication pull print job 201.

Referring to FIG. 13, when the delete selection manipulation is received in Step S529, image forming device 1 stops the reception of the print data in Step S531.

In Step S533, image forming device 1 disposes of the active authentication pull print job.

FIG. 17 is a view illustrating an example of the job information display screen after the job is disposed of according to the delete selection manipulation.

As illustrated in FIG. 17, when the authentication pull print job is disposed of while job information display screen 220 is displayed, the active job becomes only G3 fax transmission job 202. In job list 54a of the active tab 54, the information on the authentication pull print job is disposed of, and only the information on G3 fax transmission job 202 is displayed.

The disposal selection screen is not displayed, but the job information display screen may be displayed when stop key 11b is pressed in the active operation of the server cooperation job. For example, when only the server cooperation job is currently performed, the job information display screen may be displayed while the display of the disposal selection screen is omitted.

### [Description of Display Mode of Information on Job]

A display mode of the job information display screen that is displayed in pressing stop key 11b may be changed according to the number of jobs currently performed by image forming device 1, the number of temporarily-stopped jobs, or the number of waiting jobs. Plural pieces of information on the jobs to be displayed may be displayed on the job information display screen according to the kind of the job or the state of the job.

In the embodiment, the job information display screen is displayed as follows. Sometimes the number of active jobs is more than a predetermined threshold when stop key 11b is pressed. Sometimes the number of jobs, which is performed even after stop key 11b is pressed, and is displayed on the job information display screen on a priority basis, is more than a threshold in the jobs that are set to image forming device 1. In such cases, the information on each job is displayed on the job information display screen while classified into the tab (tab display area) corresponding to the kind of the job. On the other hand, when the number of jobs set to image forming device 1 is equal to or lower than a predetermined threshold, as described above, the information on each job is displayed while classified into the tab corresponding to the state (such as temporarily-stopped, waiting, and active) of the job. For example, such pieces of processing are performed under the control of CPU 21.

The number of jobs displayed on the job information display screen may be compared to the threshold in consideration of the number of temporarily-stopped jobs or waiting jobs instead of the number of active jobs.

FIG. 18 is a flowchart illustrating processing that is performed in displaying the job information display screen.

In Step S21, CPU 21 determines whether the number of jobs displayed on the job information display screen is more than the threshold. In other words, CPU 21 determines whether the information on the job is displayed on the job information display screen while classified according to the set threshold.

When the number of jobs is more than the threshold in Step S21, CPU 21 lists the pieces of information on the jobs while the pieces of information are classified into kinds of the jobs in Step S23. On the job information display screen, the information on the job is displayed in the display area of the tab corresponding to the job in the plural tabs provided in each kind of the job.

On the other hand, when the number of jobs is not more than the threshold in Step S21, CPU 21 lists the pieces of information on the jobs without classifying the pieces of information according to the kind of the job in Step S25. On the job information display screen, the information on the job is displayed in the display area of the tab corresponding to the state of the job.

For example, the threshold relating to the number of jobs may previously be set and stored in HDD 15 or ROM 23. As described below, the threshold may be changed according to the user manipulation or set as a fixed value. In the embodiment, the threshold corresponds to an upper limit of the number of jobs that are listed on the job information display screen. Accordingly, the threshold is set according to design of the job information display screen, namely, the display area or a font size.

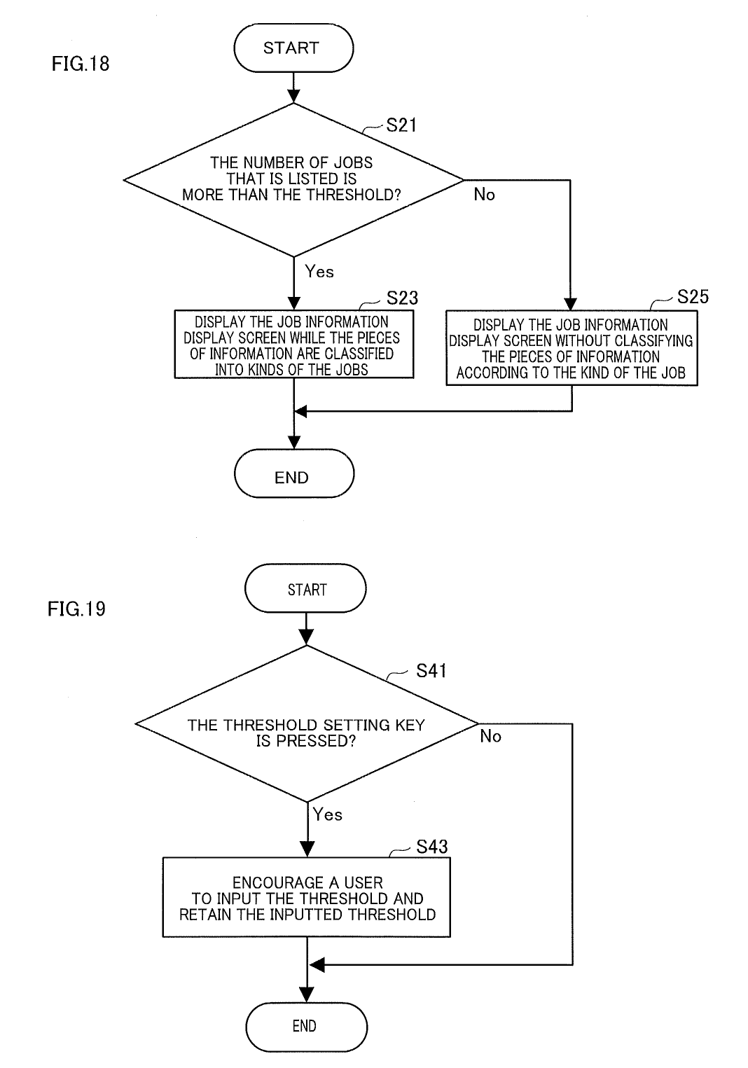

FIG. 19 is a flowchart illustrating threshold setting processing.

Image forming device 1 receives a threshold setting input from the user. For example, CPU 21 displays a function setting screen relating to various functions of image forming device 1 on display panel 13 to receive the user manipulation to set the threshold. For example, CPU 21 receives a manipulation to press a threshold setting key displayed on the function setting screen as the user manipulation to set the threshold.

As illustrated in FIG. 19, CPU 21 detects that the threshold setting key is pressed in Step S41. When the threshold setting key is pressed, CPU 21 goes to the next processing.

In Step S43, CPU 21 displays the screen in order to encourage the user to input the threshold, namely, perform the manipulation to set the number of displayed jobs, and receives the input from the user. CPU 21 retains the threshold based on the received input. For example, the threshold is stored in HDD 15 or ROM 23.

When the threshold is retained, the processing is ended. Thus, because the user can set the threshold, the job information display screen can be displayed in the desired display mode of the user. Accordingly, the user can easily recognize the information on the job.

In the embodiment, the plural pieces of information on the jobs displayed on the job information display screen are displayed according to the priority that is determined by the kind of the job or the state of the job. When the job information display screen including the plural pieces of information on the jobs is displayed, the priority is placed to each job according to the kind of the job. For the plural jobs having the same kind, the priority is placed to each job according to the operating state of the job.

As to the priority of the kinds of the jobs, the kinds of some typical unstoppable job are cited in the descending order of the priority as follows. That is, the priority is placed in the order of the G3 fax transmission job (facsimile transmission job), the network facsimile transmission job, the electronic mail transmission job, the FTP transmission job, and the server cooperation job.

G3 fax transmission job (facsimile transmission job): The G3 fax transmission is paid according to a communication time. When the G3 fax transmission job can be disposed of, a payment of an unnecessary communication fee can be prevented. Accordingly, the highest priority is placed to the G3 fax transmission job compared with other jobs when the job to be disposed of is selected.

Network facsimile transmission job: A result whether the transmission is normally performed is left on the other side of the transmission in the network facsimile. Therefore, the higher priority is placed to the network facsimile transmission job compared with the electronic mail transmission job and the like.

Electronic mail transmission job: Generally the electronic mail is frequently transmitted to the other party. Therefore, the higher priority is placed to the electronic mail transmission job compared with the file transmission job.

FTP transmission job: When the FTP transmission is performed, sometimes the transmission addressed to other person is performed although the transmission is frequently performed to the own address. Therefore, the higher priority is placed to the FTP transmission job compared with the server cooperation job.

Server cooperation job: Instead of using server 601, it is considered that the processing is solely performed by image forming device 1, and the information is not transmitted to other person. Therefore, the priority of the server cooperation job is lower than the above jobs. For example, in the searchable PDF file generating job, the output destination of the completed searchable PDF file is the BOX of image forming device 1. In this case, the image is not output to the sheet, but the lowest priority may be placed to the server cooperation job.

As to the priority of the operating state of the job, the operating states of some jobs are cited in the descending order of the priority as follows. That is, the priority is placed in the order of the active job, the temporarily-stopped job, and the waiting job.

The active job is one that is immediately stopped or disposed of, and the active job has the higher priority.

The temporarily-stopped job is one that can be resumed or disposed of. Because the user manipulation to select the resumption or the disposal can be received with respect to the temporarily-stopped job, the higher priority is placed to the temporarily-stopped job compared with the waiting job.

The waiting job has no option other than the disposal. Accordingly, the lowest priority may be placed to the waiting job compared with other jobs in the operating state.

For the plural jobs having the same kind, the higher priority may be placed to the job from the latest setting job. The user who presses stop key 11b is likely to have a motive for stopping the latest job. Therefore, convenience of image forming device 1 can be improved by displaying the latest job in a priority basis.

When the active job, the temporarily-stopped job, and the waiting job are listed while mixed, the active job is displayed at a head of the list, and the temporarily-stopped job and the waiting job are sequentially displayed. In each of the active job, the temporarily-stopped job, and the waiting job, for example, the latest job is displayed so as to be located in the upper portion of the list.

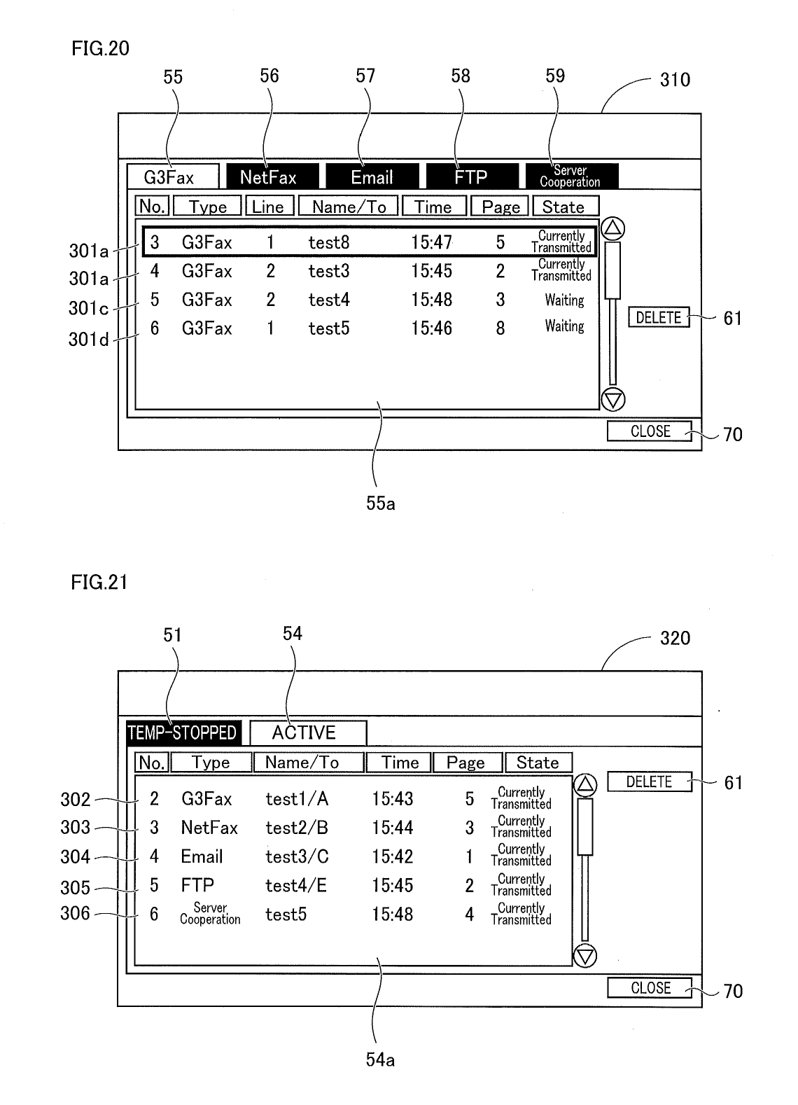

FIG. 20 is a view illustrating an example of the job information display screen when the number of jobs is more than the threshold.

It is assumed that “YES” is made in Step S21 in FIG. 18, namely, the number of active jobs that cannot be stopped is more than the threshold when stop key 11b is pressed. At this point, the information on the job set to image forming device 1 is displayed in each tab, which is classified according to the kind of the job.

As illustrated in FIG. 20, a job information display screen 310 displayed at that time includes a G3 fax tab 55, a net fax tab 56, an electronic mail tab 57, an FTP tab 58, and a server cooperation tab 59. G3 fax tab 55 corresponds to the G3 fax transmission job. Net fax tab 56 corresponds to the network facsimile transmission job. Electronic mail tab 57 corresponds to the electronic mail transmission job. FTP tab 58 corresponds to the FTP transmission job. Server cooperation tab 59 corresponds to the server cooperation job.

At the beginning of the display of job information display screen 310, in tabs 55 to 59, G3 fax tab 55 having the highest priority in the kind of the job is active while tabs 56 to 59 are inactive. In the example illustrated in FIG. 20, the pieces of information on G3 fax transmission jobs 301a to 301d are displayed in job list 55a corresponding to G3 fax tab 55. In jobs 301a to 301d, jobs 301a and 301b have the operating state of “currently-transmitted” and jobs 301c and 301d have the operating state of “waiting”. As to the job registration time (setting time), job 301b is registered earliest, and then jobs 301d, 301a, and 301c are registered.

Because jobs 301a and 301b have the operating state of “currently-transmitted”, the higher priority is placed to jobs 301a and 301b in job list 55a compared with jobs 301c and 301d having the operating state of “waiting”. The job registration time (setting time) of job 301a is later than that of job 301b by several minutes. The job registration time of job 301c is later than that of job 301d by several minutes. Accordingly, jobs 301a, 301b, 301c, and 301d are arrayed in the descending order of the priority in job list 55a.

FIG. 21 is a view illustrating an example of the job information display screen when the number of jobs is lower than the threshold.

It is assumed that “NO” is made in Step S21 in FIG. 18, namely, the number of active jobs that cannot be stopped is lower than the threshold when stop key 11b is pressed. At this point, the pieces of information on the jobs set to image forming device 1 are not classified according to the kind of the job, but the pieces of information are displayed while classified based on whether the job is active or temporarily stopped.

As illustrated in FIG. 21, a job information display screen 320 displayed at that time includes temporarily-stopped tab 51 and active tab 54. On job information display screen 320, active tab 54 is active at the time job information display screen 320 is displayed. Pieces of information on jobs of a G3 fax transmission job 302, a network facsimile transmission job 303, an electronic mail transmission job 304, an FTP transmission job 305, and a server cooperation job 306 are listed in job list 54a in this order. The registration times of jobs 302 to 306 differ from the order displayed in the list of jobs 302 to 306. Each of jobs 302 to 306 has the operating state of “currently-transmitted”.

On job information display screen 320, as described above, the pieces of information on the jobs are displayed in the descending order of the priority in the kind of the job according to the operating state. That is, the higher priority is placed to the G3 fax transmission job compared with other kinds of the jobs. When job 302 having the operating state of “currently-transmitted (active)” and the job having the operating state of “waiting” exist as the G3 fax transmission job, the higher priority is placed to job 302 having the operating state of “currently-transmitted”. Accordingly, active tab 54 in which the information on G3 fax transmission job 302 should be displayed is active when job information display screen 320 is displayed. In job list 54a of active tab 54, the pieces of information on jobs 303 to 306 are displayed subsequent to G3 fax transmission job 302 in the display order corresponding to the priority determined by the kind of the job.

In the case of many jobs, the jobs are classified into the tabs according to the kind of the job, and the job information display screen is displayed based on a rule determining the priority. When the number of jobs is increased, it takes a long time to search one job in many jobs. Therefore, even if a time necessary to select the kind of the job is generated, the time necessary for the user to search the job of the selection target can be shortened. In the case of few jobs, the jobs are not classified according to the kind of the job, and the jobs are displayed on the job information display screen so as to be able to be easily browsed. Accordingly, the user can quickly search the job of the selection target to perform the selection manipulation without the trouble of selecting the kind of the job. Accordingly, the job information display screen can be displayed in the proper display mode such that the user can quickly select the job according to the number of jobs.

In the embodiment, one of the following methods including already-described methods may be adopted in order to display information on a certain job on a priority basis. In the methods, plural methods may be combined to display the job in priority to other jobs.

When the plural pieces of information on the jobs are displayed in the same display area on the job information display screen that is visible for the user, the following method may be adopted. The information on the job having the higher priority is displayed so as to be located in the upper portion of the display area. Therefore, the information on the job having the higher priority can attract attention of the user.

When the plural pieces of information on the jobs are displayed while classified into plural display areas on the job information display screen, the following method may be adopted. At the beginning of the display of the job, information display screen, the display area including the information on the job having the higher priority is displayed in priority to other display areas. For example, when the pieces of information are displayed while classified into plural tabs, the tab corresponding to the job having the higher priority is displayed on the job information display screen while put into the active state. Therefore, the user can quickly ascertain the information on the job having the higher priority.

When the job information display screen is displayed as with the display screen in which what is called a window screen is used, and when plural jobs are displayed on plural display areas (windows), which are displayed in an overlapping manner, while classified into the display areas, the following method may be adopted. At the beginning of the display of the job information display screen, the plural display areas are displayed in the overlapping manner such that the display area including the information on the job having the higher priority is displayed on other display areas. Therefore, the user can quickly ascertain the information on the job having the higher priority.

[Description of Timing at which Stop Key 11b is Pressed and Display Mode of Information on Job]

Even in the same job, whether the job can be stopped or whether the job can be disposed of depends on timing at which stop key 11b is pressed. Therefore, even in the same job, sometimes the information on the job is displayed on the job information display screen in different modes according to the operating state in the timing at which stop key 11b is pressed. An example of the job information display screen displayed in performing the G3 fax transmission job and an example of the job information display screen displayed in performing the server cooperation job will be described below.

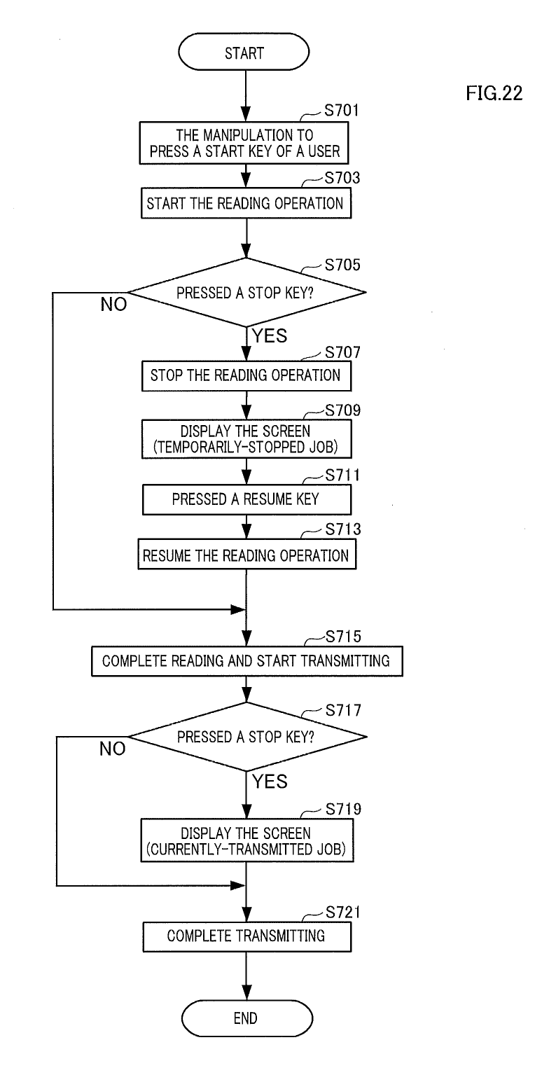

FIG. 22 is a flowchart illustrating an example of the G3 fax transmission job operation.

As illustrated in FIG. 22, the processing of the G3 fax transmission job is started in response to the manipulation input (the manipulation to press a start key) of the user in Step S701. At this point, an address of the G3 fax transmission is also assigned. When the G3 fax transmission job is started, CPU 21 receives the user manipulation to press stop key 11b until the G3 fax transmission job is completed.

In Step S703, CPU 21 causes scanner 40 to start to read the document. Automatic document conveying unit 41 reads the transmitted document.

When the user presses stop key 11b, CPU 21 receives the press of stop key 11b in Step S705 (YES in S705). When stop key 11b is not pressed, CPU 21 goes to processing in Step S715.

When the press of stop key 11b is received in Step S705, CPU 21 stops the document reading operation in Step S707. That is, at this point, the G3 fax transmission job is the stoppable job.

In Step S709, CPU 21 displays the job information display screen. That is, CPU 21 sets the G3 fax transmission job to the temporarily-stopped job, and displays the job information display screen including the information on the G3 fax transmission job.

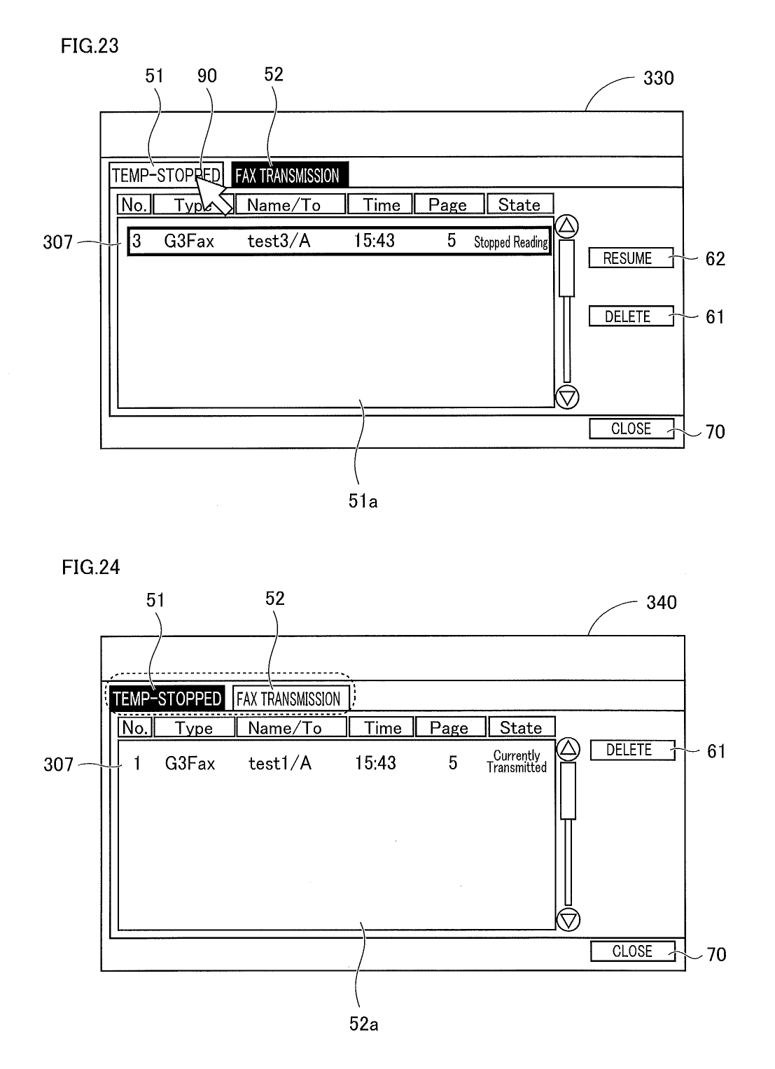

FIG. 23 is a view illustrating an example of the job information display screen.

As illustrated in FIG. 23, temporarily-stopped tab 51 and facsimile transmission tab 52 are displayed on a job information display screen 330. At this point, because the G3 fax transmission job 307 is in the state in which the reading is stopped, the information on job 307 is displayed in job list 51a of temporarily-stopped tab 51. Because job 307 can be resumed, delete key 61 and resume key 62 are displayed when job 307 is selected on job information display screen 330. In order to resume job 307, the user presses resume key 62 with job 307 selected.

Referring to FIG. 22, when the user presses resume key 62 in Step S711, CPU 21 detects that resume key 62 is pressed.

In Step S713, CPU 21 resumes the reading.

In Step S715, CPU 21 starts the transmission when the reading is completed.

When the user presses stop key 11b, CPU 21 receives the press of stop key 11b (YES in S717). When stop key 11b is not pressed, CPU 21 goes to processing in Step S721.

At this point, because the facsimile transmission is performed, the G3 fax transmission job is the unstoppable job. Therefore, when the press of stop key 11b is received in Step S717, CPU 21 displays the job information display screen in Step S719. CPU 21 sets the G3 fax transmission job to the currently-transmitted job, and displays the job information display screen including the information on the G3 fax transmission job. In response to the instruction from the user, the job information display screen may be displayed after disposal selection screen 110.

FIG. 24 is a view illustrating an example of the job information display screen.

As illustrated in FIG. 24, a job information display screen 340 includes temporarily-stopped tab 51 and facsimile transmission tab 52. At this point, G3 fax transmission job 307 is not stopped, but currently performed. Therefore, the information on job 307 is displayed in job list 52a of facsimile transmission tab 52. Although not resumed, job 307 can be disposed of. Therefore, only delete key 61 is displayed on job information display screen 340. At this point, the user selects job 307 to perform the manipulation to select delete key 61, which allows job 307 to be disposed of. When the processing is performed to the end of the transmission, the processing is ended.

Referring to FIG. 22, CPU 21 completes the transmission in Step S721, the G3 fax transmission job is completed.

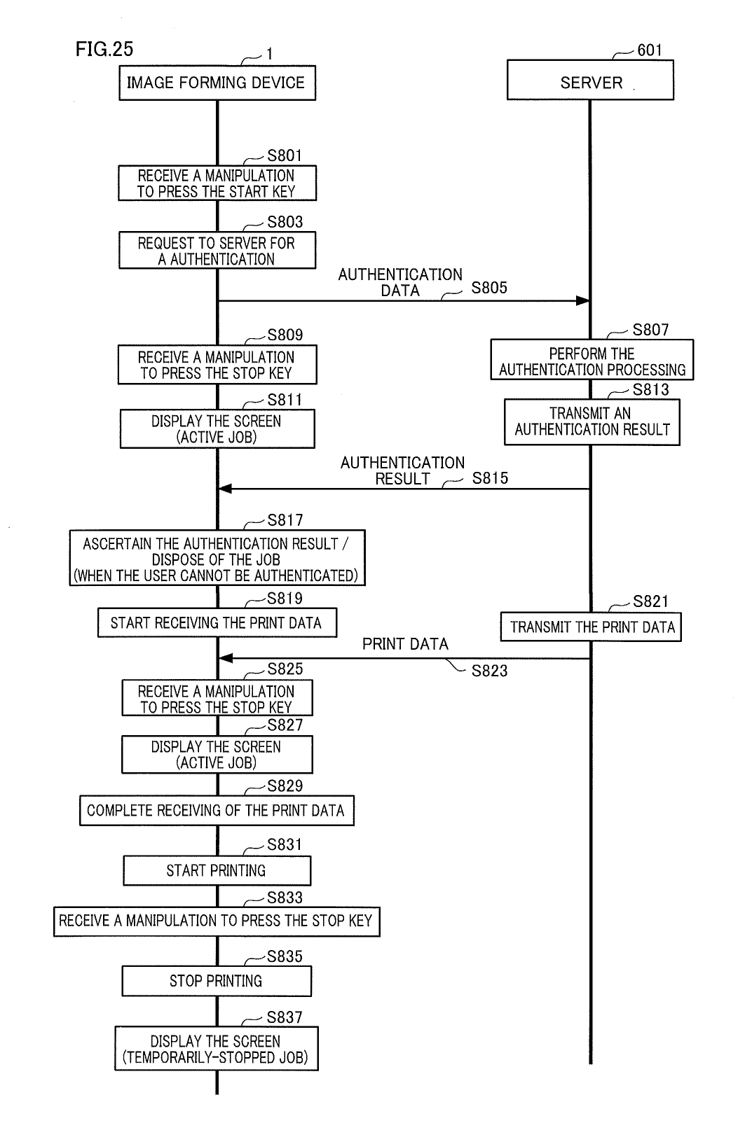

FIG. 25 is a flowchart illustrating and example of an operation of the authentication pull print job.

Referring to FIG. 25, because pieces of processing in Steps S801 to S827 are identical to those in Steps S501 to S527 in FIG. 13, the description is omitted. In the example in FIG. 25, it is assumed that, in Steps S825 and S827, the manipulation to dispose of the authentication pull print job is not performed when stop key 11b is pressed while the print data is received.

When the job is not disposed of although stop key 11b is pressed, image forming device 1 completes the reception of the print data in Step S829.

In Step S831, image forming device 1 starts the printing based on the received print data.

At this point, when the user presses stop key 11b, image forming device 1 receives the press of stop key 11b in Step S833.

When the press of stop key 11b is received in Step S833, image forming device 1 stops the printing operation in Step S835. That is, at this point, the authentication pull print job is the stoppable job.

In Step S837, image forming device 1 displays the job information display screen. Image forming device 1 sets the authentication pull print job to the temporarily-stopped job, and displays the job information display screen including the information on the authentication pull print job.

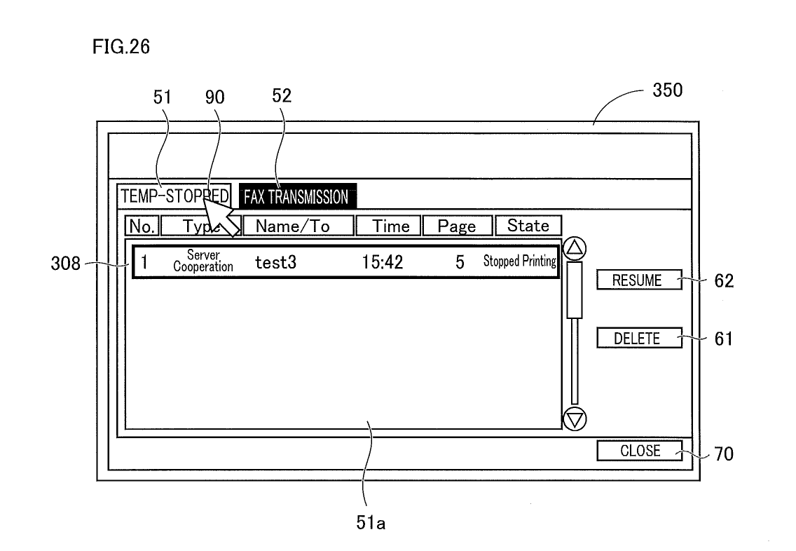

FIG. 26 is a view illustrating an example of the job information display screen.

As illustrated in FIG. 26, temporarily-stopped tab 51 and facsimile transmission tab 52 are displayed on a job information display screen 350. At this point, because the authentication pull print job 308 is in the state in which the reading is stopped, the information on job 308 is displayed in job list 51a of temporarily-stopped tab 51. Because job 308 can be resumed, delete key 61 and resume key 62 are displayed when job 308 is selected on job information display screen 330. When the user presses resume key 62, the printing is resumed. When the user presses delete key 61, authentication pull print job 307 is disposed of.

### Advantageous Effect of Embodiment

In image forming device 1 having the above configuration, when the job information display screen is displayed to select the job of the disposal target, the active job is displayed on a priority basis. At this point, the disposable job is displayed in priority to the indisposable job. After the job information display screen is displayed according to the priority rule, the user properly performs the manipulation to switch the tab, allowing other jobs to be displayed to perform the desired manipulation. Because the active job is displayed on a priority basis, the user can quickly and surely recognize that the job, in which whether the operation is stopped is hardly visually determined, is currently performed. Because the disposable job is displayed on a priority basis, the processing of disposing of the job can easily be performed in a simple procedure. The active job that may become the disposal target is displayed on a priority basis, so that the user can quickly issue the disposal instruction.

In image forming device 1, the disposal selection screen on which the user is encouraged to select whether the active job is disposed of is displayed in the predetermined case before the job information display screen is displayed. Therefore, the user can quickly recognize the existence of the active job.

### [Others]

The kind of the jobs set to image forming device 1 or the number of jobs is not limited to the embodiment. For example, image forming device 1 may perform a file transmission job of performing the transmission using protocols, such as SMB (Server Message Block) and WebDAV (Web-based Distributed Authoring and Versioning), instead of the FTP.

When the stop key is pressed, the disposal selection screen is not displayed but the job information display screen is immediately displayed, whereby the user may be noticed that the active job exists.

The job priority that is considered in displaying the job information display screen may be determined by another factor. For example, it is assumed that, in the facsimile transmission job or the electronic mail transmission job, the job having the same kind is addressed to other person out of a predetermined group, such as out of a company. In this case, the higher priority may be placed compared with the job addressed to other person in the group.

The job priority may be determined in consideration of various factors, such as the kind of the job, the registration time of the job, the operating state of the job, and the transmission destination. For example, the job priority may be determined while the highest value is placed on the registration time of the job or the transmission destination.

The image forming device may be any of a black-and-white or color copier, printer, facsimile machine, or a multi-function peripheral (MFP) as a combination thereof. The image forming device is not restricted to the one which forms images by electrophotography, but may be the one which forms images by a so-called inkjet system.

The image processing device of the invention can also be applied to an image reading device (an example of the image processing device) that does not include the image forming unit or an image forming device that includes not the reading unit but the image forming unit.

The processes according to the above embodiments may be performed by software or by using a hardware circuit.

A program for executing the processes according to the above embodiments may be provided as well. The program may be recorded on a recording medium, such as a CD-ROM, flexible disk, hard disk, ROM, RAM, memory card, or the like, so as to be provided to the user. The program may also be downloaded to the device via a communication line such as the Internet. The processes described in conjunction with the flowcharts above are executed by a CPU and the like in accordance with the program.

According to the embodiment, when the stop request is received, the information on the second kind of job in which the sheet conveying operation is not performed in the active jobs is displayed to the user. Accordingly, the image processing device and the image forming device in which, when the stop request is made during the temporarily unstoppable job, the user can easily recognize that the temporarily unstoppable job is currently performed can be provided.

It should be understood that the embodiments described above are illustrative and non-restrictive in every respect. The scope of the present invention is defined by the terms of the claims, rather than the description above, and is intended to include any modifications within the scope and meaning equivalent to the terms of the claims.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing device comprising:
a conveying unit for performing a sheet conveying operation;
a receiving unit for receiving a stop request from a user to stop a job that is currently performed by said image processing device;
a stopping instruction unit for stopping a first kind of job when said first kind of job exists in the case that said receiving unit receives said stop request, the first kind of job being a job in which said sheet conveying operation is performed by said conveying unit in jobs that are currently performed by said image processing device;
a determination unit for determining a second kind of job different from said first kind of job in the jobs that are currently performed by said image processing device when said receiving unit receives said stop request; and
a job display unit for displaying information on said second kind of job to the user based on a determination result of said determination unit.

2. The image processing device according to claim 1, wherein said second kind of job includes at least one of a job of performing a facsimile transmission operation through an audio line or a digital line, a job of performing a network facsimile transmission operation, a job of performing an electronic mail transmission operation, a job of performing a file transfer operation, a job of storing information in a storage device, and a job of performing processing in an external server.

3. The image processing device according to claim 2, wherein said processing in said external server includes at least one of image processing, authentication data transmission processing, and image data transmission processing.

4. The image processing device according to claim 1, further comprising
a selection display unit for displaying information encouraging the user to select whether a job is disposed of when the job that is not stopped by said stopping instruction unit exists in the jobs that are currently performed by said image processing device in the case that said receiving unit receives said stop request, wherein
said job display unit displays the information on said second kind of job when the user selects the disposal of the job according to the display of said selection display unit.

5. The image processing device according to claim 1, wherein said job display unit displays the information on said second kind of job to the user in priority to said information on said first kind of job when said first kind of job and said second kind of job exist in the case that said receiving unit receives said stop request.

6. The image processing device according to claim 1, wherein said job display unit displays the information on said second kind of job to the user in priority to a temporarily-stopped job and a waiting job when said second kind of job, the temporarily-stopped job, and the waiting job exist in the ease that said receiving unit receives said stop request.

7. The image processing device according to claim 1, wherein said job display unit displays the information on said second kind of job that cannot be disposed of to the user in priority to a temporarily-stopped job, and displays the information on said second kind of job that cannot be disposed of to the user while a priority is not placed to said second kind of job that cannot be disposed of compared with said second kind of job that can be disposed of when said second kind of job that cannot be disposed of exists in the case that said receiving unit receives said stop request.

8. The image processing device according to claim 5, wherein said display to the user on a priority basis is one of:
displaying information on a job having a priority in a display area displayed on a screen, which can visibly be recognize by the user, such that the information is located in an upper portion of said display area;
displaying a display area including the information on the job having the priority in priority to other display areas at the beginning of the display when a plurality of pieces of information on jobs are displayed while classified into a plurality of display areas displayed on the screen that can visibly be recognize by the user; and
displaying the plurality of display areas in an overlapping manner such that the display area including the information on the job having the priority is displayed on other display areas at the beginning of the display when the plurality of pieces of information on the jobs are displayed in the overlapping manner while classified into the plurality of display areas displayed on the screen that can visibly be recognize by the user.

9. The image processing device according to claim 1, further comprising:
a setting unit for setting a threshold relating to the number of jobs in which the pieces of information are displayed by said job display unit; and
a display determination unit for determining whether said job display unit displays the pieces of information on the jobs while classifying the pieces of information on the jobs according to the threshold set by said setting unit, wherein
said job display unit displays the pieces of information on the jobs to be displayed while classifying the pieces of information on the jobs when said display determination unit determines that said job display unit displays the pieces of information on the jobs while classifying the pieces of information on the jobs in the case that said receiving unit receives said stop request.

10. The image processing device according to claim 1, further comprising a reader for reading a document, wherein
said conveying unit performs an operation to convey the document read by said reader.

11. An image forming device comprising:
an image forming unit for forming an image on a sheet; and
the image processing device according to claim 1, wherein
said conveying unit performs the operation to convey the sheet used in said image forming unit.

12. A method for controlling an image processing device including a conveying unit for performing a sheet conveying operation, comprising:
a receiving step of receiving a stop request from a user to stop a job that is currently performed by said image processing device;
a job stopping step of stopping a first kind of job when said first kind of job exists in the case that said stop request is received in said receiving step, the first kind of job being a job in which said sheet conveying operation is performed by said conveying unit in jobs that are currently performed by said image processing device;
a determination step of determining a second kind of job different from said first kind of job in the jobs that are currently performed by said image processing device when said stop request is received in said receiving step; and
a job displaying step of displaying information on said second kind of job to the user based on a determination result in said determination step.

13. A non-transitory computer-readable recording medium encoded with a program for controlling an image processing device including a conveying unit for performing a sheet conveying operation, said program causing a computer to execute process comprising:
a receiving step of receiving a stop request from a user to stop a job that is currently performed by said image processing device;
a job stopping step of stopping a first kind of job when said first kind of job exists in the case that said stop request is received in said receiving step, the first kind of job being a job in which said sheet conveying operation is performed by said conveying unit in jobs that are currently performed by said image processing device;
a determination step of determining a second kind of job different from said first kind of job in the jobs that are currently performed by said image processing device when said stop request is received in said receiving step; and
a job displaying step of displaying information on said second kind of job to the user based on a determination result in said determination step.
